(19) United States
(12) Patent Application Publication
(10) Pub. No.: US 2019/0043038 A1
(43) Pub. Date: Feb. 7, 2019

(54) MOBILE DEVICE AND CONTROL METHOD THEREFOR

(71) Applicant: LG ELECTRONICS INC., Seoul (KR)

(72) Inventors: Hyukjoon JANG, Seoul (KR); Kyungdong CHOI, Seoul (KR)

(73) Assignee: LG ELECTRONICS INC., Seoul (KR)

(21) Appl. No.: 16/073,626

(22) PCT Filed: Jan. 29, 2016
(86) PCT No.: PCT/KR2016/000981

§ 371 Date: Jul. 27, 2018

(51) Int. Cl. G06Q 20/32; G06K 9/00; G06Q 20/20

(52) U.S. Cl. CPC G06Q 20/3278; G06F 3/04886; G06Q 20/204; G06K 9/00671

(57) ABSTRACT

A mobile device according to one embodiment of the present invention comprises: a camera; a touch sensor; a display module; a near field communication module; a memory in which at least one piece of card information capable of paying for an item is stored; and a controller for controlling the touch sensor, the display module and the memory. Particularly, the controller controls the display module in response to a command for executing a payment function, such that a preset specific region, in which the card information stored in the memory can be read, is displayed distinctly from other regions.

### TECHNICAL FIELD

The present disclosure relates to a mobile device and a control method therefor, and more particularly, to a technique applicable to, for example, a mobile device equipped with a payment-related function.

### BACKGROUND ART

Recently, mobile payment through mobile devices (e.g., portable phones, smartphones, tablet PCs, smart watches, glasses, etc.) has been widely adopted. A mobile payment is made mainly by, for example, magnetic secure transmission (MST) and near field communication (NFC).

MST is advantageous in that an MST terminal capable of conventional card payment can be used, whereas NFC is superior to MST in security, despite the requirement of installation of an NFC-enabled terminal in a business place.

Meanwhile, mobile devices are only MST-enabled, only NFC-enabled, or NFC and MST-enabled. However, when a payment is made with a mobile device at a POS terminal in a business place, the payment becomes successful only when a specific position (e.g., MST antenna/coil or NFC antenna/coil) of the mobile device contacts the POS terminal.

However, most of users know neither the accurate position of the MST antenna/coil or NFC antenna/coil of their mobile devices, nor the spot of a POS terminal to be contacted. Accordingly, a relatively long time is taken to pay with a mobile device.

### DISCLOSURE

### Technical Problem

An embodiment of the present disclosure is intended to significantly shorten a time taken for making a payment with a mobile device by guiding to the position of an MST or NFC antenna (coil), when a payment is made with the mobile device.

Another embodiment of the present disclosure is to provide a technical solution of guiding to payment at a specific position of a POS terminal, when a payment is made with a mobile device.

Another embodiment of the present disclosure is to provide a method of fast completing a mobile payment or wireless charging, when a mobile device is provided with a side display or a haptic function.

### Technical Solution

In an aspect of the present disclosure, a mobile device includes a camera, a touch sensor, a display module, a short-range communication module, a memory configured to store information about at least one card enabling payment for an item, and a controller configured to control the touch sensor, the display module, and the memory. The controller is configured to control the display module to display a predetermined specific area in which the information about at least one card stored in the memory is to be read, distinctly from other areas, in response to a command for executing a payment function.

In another aspect of the present disclosure, a method of controlling a mobile device includes storing information about at least one card enabling payment for an item in a memory, recognizing a command for executing a payment function, accessing the memory, and controlling display of a predetermined specific area in which the information about at least one card stored in the memory is to be read, distinctly from other areas.

### Advantageous Effects

According to an embodiment of the present disclosure, the technical effect is achieved that a time taken for making a payment with a mobile device is significantly reduced by guiding to the position of an MST or NFC antenna (coil), when a payment is made with the mobile device.

According to another embodiment of the present disclosure, when a payment is made with a mobile device, a technical solution of guiding to payment at a specific position of a POS terminal can be provided.

According to another embodiment of the present disclosure, the technical effect is achieved that when a mobile device is provided with a side display or a haptic function, a mobile payment or wireless charging can be completed fast.

### BRIEF DESCRIPTION OF THE DRAWINGS

FIG. 1A is a block diagram of a mobile terminal related to the present disclosure.

FIGS. 1B and 1C are conceptual views illustrating an exemplary mobile terminal related to the present disclosure, seen from different directions.

FIG. 2 is a conceptual view illustrating another exemplary mobile terminal which may be modified according to the present disclosure.

FIG. 3 is a perspective view illustrating an exemplary watch-type mobile terminal related to another embodiment of the present disclosure.

FIG. 4 is a perspective view illustrating an exemplary glasses-type mobile terminal related to another embodiment of the present disclosure.

FIG. 5 illustrates an exemplary area of a mobile device in which an antenna for mobile payment is disposed.

FIG. 6 illustrates another exemplary area of a mobile device in which an antenna for mobile payment is disposed.

FIG. 7 illustrates specific areas of POS terminals in which a credit card or an MST-enabled mobile device can be recognized.

FIG. 8 illustrates a mobile device equipped with a mobile payment function according to an embodiment of the present disclosure.

FIG. 9 illustrates an example of starting a payment function by using a mobile device according to an embodiment of the present disclosure.

FIG. 10 illustrates another example of starting a payment function by using a mobile device according to an embodiment of the present disclosure.

FIG. 11 illustrates a process of making a payment on an NFC-enabled POS terminal with a mobile device according to an embodiment of the present disclosure.

FIG. 12 illustrates a process of making a payment on an MST-enabled POS terminal with a mobile device according to an embodiment of the present disclosure.

FIG. 13 illustrates a situation in which a mobile device is required to execute a payment function through a solution other than its front display according to an embodiment of the present disclosure.

FIG. 14 illustrates a process of executing a payment function by using a side display of a mobile device in order to solve the problem illustrated in FIG. 13.

FIG. 15 illustrates a process of executing a payment function by a haptic operation of a mobile device in order to solve the problem illustrated in FIG. 13.

FIG. 16 illustrates a case in which a mobile device is applied to IoT control, instead of mobile payment according to an embodiment of the present disclosure.

FIG. 17 illustrates an embodiment of a graphical user interface (GUI) used during mobile payment in a mobile device according to an embodiment of the present disclosure.

FIG. 18 illustrates another embodiment of a GUI used during mobile payment in a mobile device according to an embodiment of the present disclosure.

FIG. 19 illustrates a third embodiment of a GUI used during mobile payment in a mobile device according to an embodiment of the present disclosure.

FIG. 20 illustrates a fourth embodiment of a GUI used during mobile payment in a mobile device according to an embodiment of the present disclosure.

FIG. 21 illustrates a fifth embodiment of a GUI used during mobile payment in a mobile device according to an embodiment of the present disclosure.

FIG. 22 illustrates a process of performing wireless charging in a mobile device according to another embodiment of the present disclosure.

FIG. 23 illustrates a process of performing wireless charging in a mobile device according to another embodiment of the present disclosure.

FIG. 24 is a flowchart illustrating a process of making a payment in a mobile device according to an embodiment of the present disclosure.

### BEST MODE FOR CARRYING OUT THE INVENTION

Hereinbelow, embodiments of the present disclosure will be described in detail with reference to the accompanying drawings. Irrespective of figure numbers, the same or similar components are denoted by like reference numerals, and a redundant description of the components is avoided. In the following description, postfixes attached to the names of components, “module” and “unit” are assigned or interchangeably used only in consideration of ease of the description, and do not have differentiated meanings or functions.

Further, lest it should obscure the subject matter of the embodiments of the present disclosure, a related known technology is not described.

In addition, the accompanying drawings are given only to help with the understanding of the embodiments of the present disclosure, not limiting the technical spirit of the present disclosure, and it is to be understood that the disclosure covers all modifications, equivalents, and alternatives falling within the scope and spirit of the disclosure.

Terms including an ordinal number such as first or second may be used to describe various components, not limiting the components. The terms are used only for the purpose of distinguishing one component from another component.

When it is said that a component is “coupled with/to” or “connected to” another component, it should be understood that the one component is connected to the other component directly or through any other component. On the other hand, when it is said that a component is “directly coupled to” or “directly connected to” another component, it may be understood that there is no other component between the components.

Unless the context clearly dictates otherwise, singular forms include plural referents.

In the present disclosure, it is to be understood that the term “include” or “have” signifies the presence of a feature, a number, a step, an operation, a component, or a part, or a combination thereof as described in the disclosure, not excluding the presence or the possibility of addition of one or more other features, numbers, steps, components, or parts, or combinations thereof.

A mobile terminal as described in the present disclosure may be any of a portable phone, a smartphone, a laptop computer, a digital broadcasting terminal, a personal digital assistant (PDA), a portable multimedia player (PMP), a navigation device, a slate PC, a tablet PC, an ultrabook, a wearable device (e.g., a watch-type terminal (smart watch), a glasses-type terminal (smart glasses), and a head mounted display (HMD)), and so on.

However, it will be easily understood to those skilled in the art that a configuration according to an embodiment of the present disclosure is also applicable to a fixed terminal such as a digital TV, a desktop computer, or a digital signage, unless the configuration is applied only to a mobile terminal.

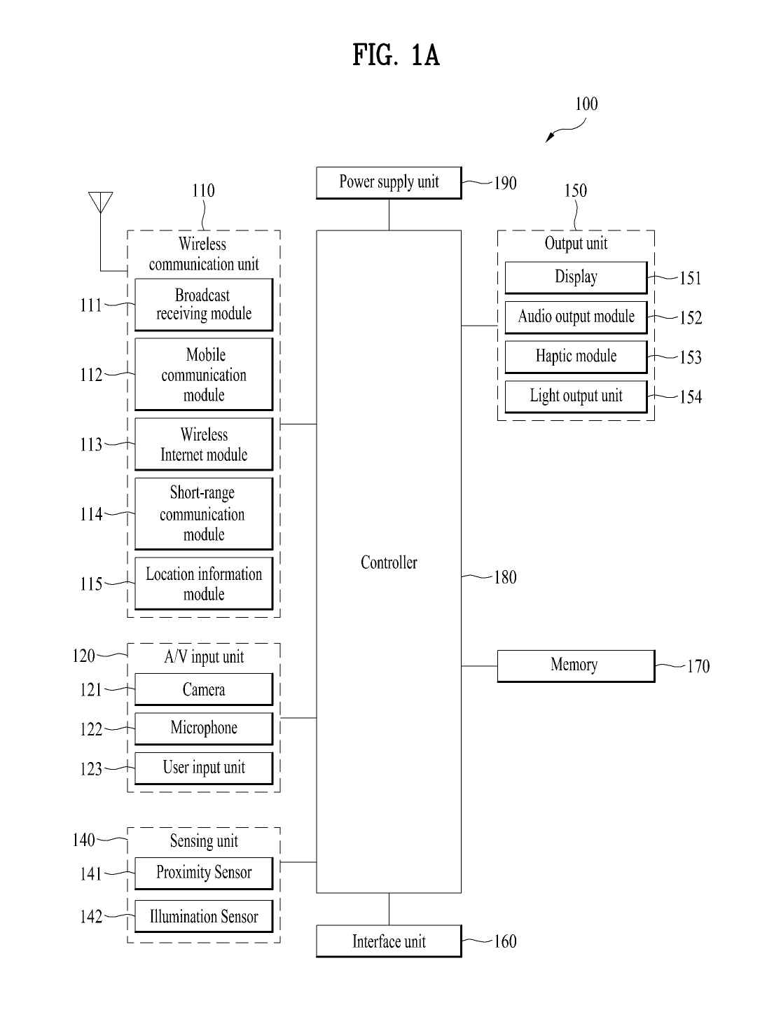

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a position location module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, information and the like inputted or outputted through the above-mentioned components and/or runs application programs saved in the memory 170, thereby processing or providing a user with appropriate information and/or functions.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast management server generates a broadcast signal and/or broadcast-related information, and receives the transmitting server or the generated broadcasting signal and/or broadcasting related information, may indicate a server that transmits to a terminal. The broadcast signal includes a TV broadcast signal, a radio broadcast signal, and a data broadcast signal, as well as a TV broadcast signal or it is also possible to include a broadcast signal in which a data broadcast signal is combined with a radio broadcast signal.

The broadcast signal may be encoded according to at least one of the technical standards (or broadcasting system, for example, ISO, IEC, DVB) for transmitting and receiving digital broadcast signals. And the broadcast receiving module 111 can receive the digital broadcast signal using a method conforming to the technical standards defined in the technical standards.

The broadcast-related information may indicate a broadcast channel, a broadcast program, or information related to broadcast service provider. The broadcast-related information can also be provided through a mobile communication network. In this case, the mobile communication module 112 may receive the broadcast-related information.

The broadcast-related information includes, for example, a DMB (Digital Multimedia Broadcasting), EPG (Electronic Program Guide) or an ESG (Electronic Service Guide) of a DVB-H (Digital Video Broadcast-Handheld). The broadcast signal and/or broadcast related information received through the broadcast receiving module 111 may be stored in the memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX). High Speed Downlink Packet Access (HSDPA), HSUPA (High Speed Uplink Packet Access). Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The position-location module 115 is generally configured to detect, calculate, derive or otherwise identify a position of the mobile terminal. As an example, the position-location module 115 includes a Global Position System (GPS) module, a Wi-Fi module, or both. If desired, the position-location module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 100. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

Generally, 3D stereoscopic images are composed of left image (left eye image) and right image). According to the way in which left and right images are combined into three-dimensional stereoscopic images, a top-down method in which left and right images are arranged vertically in one frame, method, a left-to-right (L-to-R) side-by-side method in which left and right images are arranged left and right in one frame, board (checker board) method, the left image and the right image are alternately arranged in a column unit or a row unit interlaced, and left and right images by time sequential (frame-by-frame) method.

In addition, the 3D thumbnail image is obtained from the left and right images of the original image frame a left-image thumbnail and a right-image thumbnail, respectively, and as they are combined and can be generated as one image. Generally, a thumbnail is a reduced image or a reduced still image. The generated left image thumbnail and right image the thumbnail is displayed on the screen by a depth corresponding to the parallax between the left and right images by displaying the difference between the left and right distances, it is possible to exhibit stereoscopic spatial feeling.

The left and right images required for the implementation of the three-dimensional image are processed by the stereoscopic processing unit and can be displayed on the stereoscopic display unit. The stereoscopic processing unit displays 3D images and the image of the extension point of time) from the left image and the right image, or a 2D image is inputted and converted into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 can receive external power or provide internal power and supply the appropriate power required for operating respective elements and components included in the mobile terminal 100. The power supply unit 190 may include a battery, which is typically rechargeable or be detachably coupled to the terminal body for charging.

Also, the power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Also, various embodiments can be implemented in the computer and similar recording materials using software, hardware and the combination of software and hardware.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the 1st audio output unit 152a, the 2nd audio output unit 152b, the proximity sensor 141, the illumination sensor 142, the light output unit 154, the 1st camera 121a, the 2nd camera 121b, the 1st manipulating unit 123a, the 2nd manipulating unit 123b, the microphone 122, the interface unit 160, and the like.

FIGS. 1B and 1C depict certain components as arranged on the mobile terminal.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 15a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

In the figure, the first operation unit 123a is a touch key, the invention is not limited thereto. For example, the first operation unit 123a a mechanical key, or a combination of a touch key and a touch key.

The contents input by the first and second operation units 123a and 123b are variously set can be. For example, the first operation unit 123a may issue a command such as a menu, a home key, a cancel, and the second operation unit 123b receives the first sound output from the first or second sound output unit 152a or 152b the size of the sound to be output, and the switch to the touch recognition mode of the display unit 151 can be input.

The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, in the present invention, it can be displayed using a flexible display. In the following, this will be discussed in more detail with attached drawings.

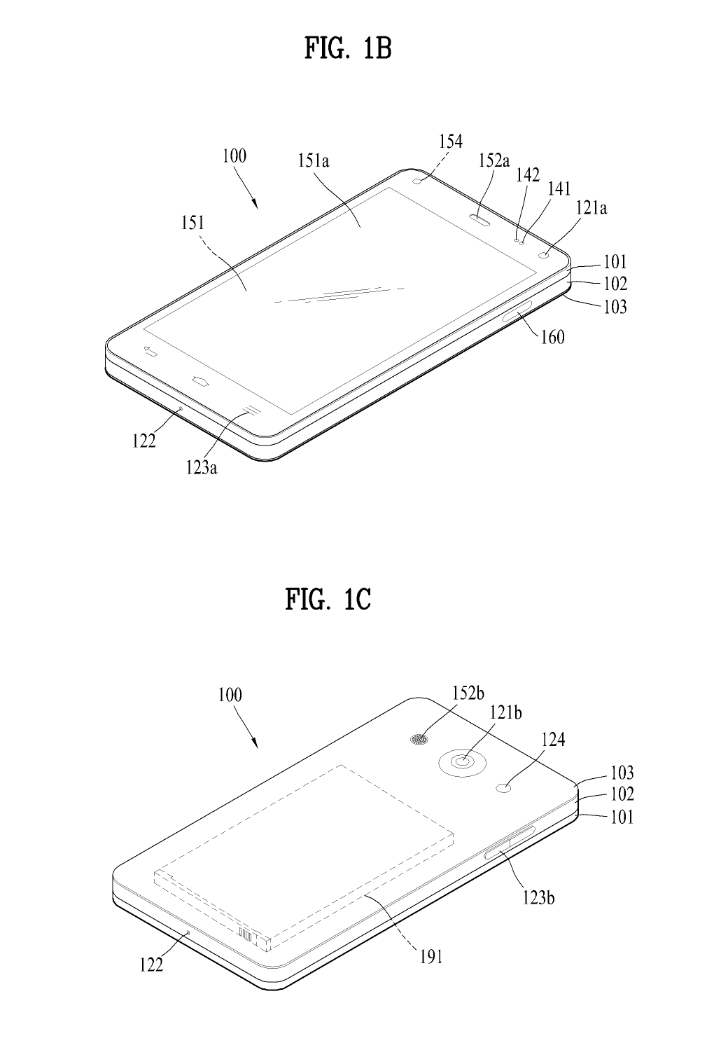

FIG. 2 is a conceptual view to describe another example of a deformable mobile terminal 200 according to the present invention.

Referring to FIG. 2, a display unit 251 may be configured deformable in response to an external force. This deformation may include at last one of curving, bending, folding, twisting, rolling, and combinations thereof. The deformable display unit 251 may be named “flexible display unit”. In particular, the flexible display unit 251 may include a general flexible display, an electronic paper (also known as e-paper), and a combination thereof. In general, a mobile terminal 200 may be configured to include the same or similar features of the former mobile terminal 100 shown in FIGS. 1A to 1C.

Generally, a flexible display means a display that is light-weighted and non-fragile in a manner of being fabricated on a thin and flexible substrate having such properties of paper as curving, bending, folding, twisting, and rolling while maintaining the properties of an existing flat panel display.

The e-paper may be used to refer to a display technology that employs the properties of a general ink. The e-paper is different from the existing flat panel display in using reflective light. The e-paper is generally understood as changing displayed information by electrophoresis using twist balls or capsules.

In a state that the flexible display unit 251 is not deformed (for example, a state that the flexible display unit 251 has an infinite radius of curvature, referred to as a 1^{st} state), a display region of the flexible display unit 251 becomes a flat surface. In a state that the flexible display unit 251 is deformed from the 1^{st} state by an external force (for example, a state that the flexible display unit 251 has a finite radius of curvature, referred to as a 2^{nd} state), the display region may become a curved surface or a bent surface. As illustrated, information displayed in the second state may include a visual information outputted through the curved surface. The visual information may be implemented in a manner that light emission of each unit pixel (sub-pixel) arranged in a matrix configuration is controlled independently. In this case, the unit pixel denotes an elementary unit for representing a single color.

The flexible display unit 251 may enter not a flat state but a curved state (for example, a vertically curved state, a horizontally curved state, etc.) in the Is' state. In doing so, if an external force is applied to the flexible display unit 251, the flexible display unit 251 may be deformed into a flat state (or a less curved state) or a more curved state.

If desired, the flexible display unit 251 may embody a flexible touchscreen by being combined with a touch sensor. If a touch is applied to the flexible touchscreen, the controller 180 (cf. FIG. 1A) can perform a control in response to the touch input. The flexible touchscreen may be configured to sense a touch input not only in the 1^{st} state but also in the 2^{nd} state.

Meanwhile, the mobile terminal 200 according to the modified example may include a deformation sensing means for sensing the deformation of the flexible display unit 251. The deformation sensing means may be included in the sensing unit 140 shown in FIG. 1A.

The deformation sensing means is provided to the flexible display unit 251 or the case 201 to sense information related to the deformation of the flexible display unit 251. Examples of such information related to the deformation of the flexible display unit 251 may include a deformed direction of the flexible display unit 251, a deformed degree of the flexible display unit 251, a deformed position of the flexible display unit 251, a deformed time of the flexible display unit 251, an acceleration for restoring the deformed flexible display unit 251, and the like. Besides, the information may include various kinds of information that can be sensed owing to the curving of the flexible display unit 251.

The controller 180 can change the information displayed on the flexible display unit 251 or generate a control signal for controlling a function of the mobile terminal 200, based on the information related to the deformation of the flexible display unit 251. Such information is typically sensed by the deformation sensing means.

The mobile terminal 200 according to the modified example may include a case 201 for accommodating the flexible display unit 251. The case 201 can be configured deformable together with the flexible display unit 251 in consideration of the property of the flexible display unit 251.

A battery (not shown in the drawing) provided to the mobile terminal 200 may be configured deformable by an external force together with the flexible display unit 251 in consideration of the property of the flexible display unit 251. In order to embody such a battery, it is able to employ a stack and folding scheme of stacking battery cells on each other.

The state deformation of the flexible display unit 251 is non-limited by the case of applying the external force. For example, the flexible display unit 251 can be deformed into the 2^{nd} state in response a command given by a user or application when the flexible display unit 251 is in the 1^{st} state.

Beyond using a mobile terminal grabbed with a user's hand, the mobile terminal may extend to a wearable device that is wearable on a user body. Examples of the wearable device include a smart watch, a smart glass, a head mounted display (HMD), and the like. Examples of the mobile terminal extending to the wearable devices shall be described as follows.

First of all, a typical wearable device can exchange data with (or interwork with) another mobile terminal 100. The short-range communication module 114 can sense or recognize a nearby wearable device capable of communicating with the mobile terminal 100. Moreover, if the sensed wearable device is a device authenticated to communicate with the mobile terminal 100, the controller 180 may transmit at least one portion of the data processed in the mobile terminal 100 to the wearable device via the short-range communication module 114, for example. Hence, a user can use the data processed in the mobile terminal 100 through the wearable device. For example, when an incoming call is received by the mobile terminal 100, the user can answer the incoming call through the wearable device. When a message is received by the mobile terminal 100, the user can check the received message through the wearable device.

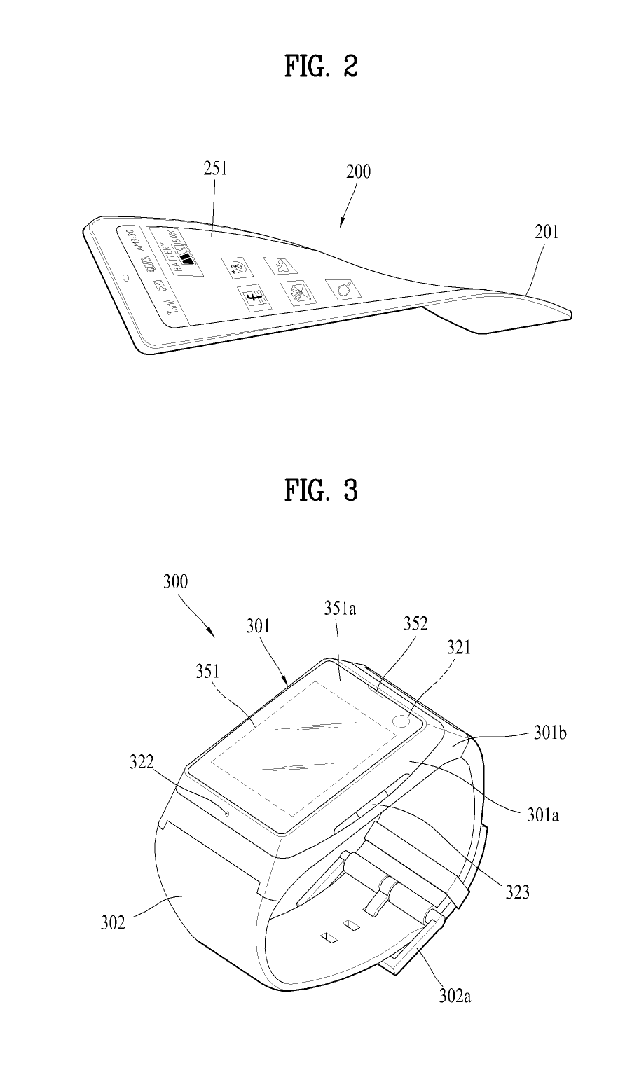

FIG. 3 is a perspective diagram for one example of a watch type mobile terminal 300 related to another embodiment of the present invention.

Referring to FIG. 3, a mobile terminal 300 of a watch type may include a main body 301 having a display unit 351 and a band 302 connected to the main body 301 to be wearable on a wrist. In general, the mobile terminal 300 may be configured to include features that are the same or similar to those of the former mobile terminal 100 shown in FIGS. 1A to 1C.

The main body 301 may include a case forming a certain appearance or exterior. As illustrated, the case may include a 1^{st} case 301a and a 2^{nd} case 301b configured to cooperatively provide an inner space for accommodating various electronic components therein, by which the present invention is non-limited. For instance, a single case is configured to provide the inner space, thereby embodying the mobile terminal 300 of a uni-body type.

The watch type mobile terminal 300 is configured to perform wireless communication, and an antenna for the wireless communication can be installed in the main body 301. It is able to expand performance of the antenna using the case. For example, a case containing a conductive material is electrically connected to the antenna to extend a ground region or a radiation region.

The display unit 351 is disposed on the front side of the main body 301 so as to output information. The display unit 351 is provided with a touch sensor so as to be embodied into a touchscreen. As illustrated, a window 351a of the display unit 251 is mounted on the 1^{st} case 301a to form a front surface of the terminal body together with the 1^{st} case 301a.

The main body 301 may be provided with an audio output unit 352, a camera 321, a microphone 322, a user input unit 323 and the like. In case that the display unit 351 is embodiment into the touchscreen, it can function as a user input unit 323. Hence, a separate key may not be provided to the main body 301.

The band 302 is configured to be worn on a wrist by enclosing the wrist. And, the band 302 may be formed of a flexible material for facilitating the wearing of the device. As one example, the band 302 may be made of leather, rubber, silicon, synthetic resin, and/or the like. As the band 302 is configured detachable from the main body 301, the band 302 may be substituted with various types of bands according to a user's preference.

Meanwhile, the band 302 may be used to expand the performance of the antenna. For example, a ground extending portion (not shown in the drawing) for extending a ground region by being electrically connected to the antenna may be built in the band 302.

The band 302 may include a fastener 302a. The fastener 302a may be embodied into a buckle type, a snap-fit hook structure, a Velcro® type, and/or the like. The fastener 302a may include a retractile section or material. According to the example shown in the present drawing, the fastener 302a is embodied into the buckle type.

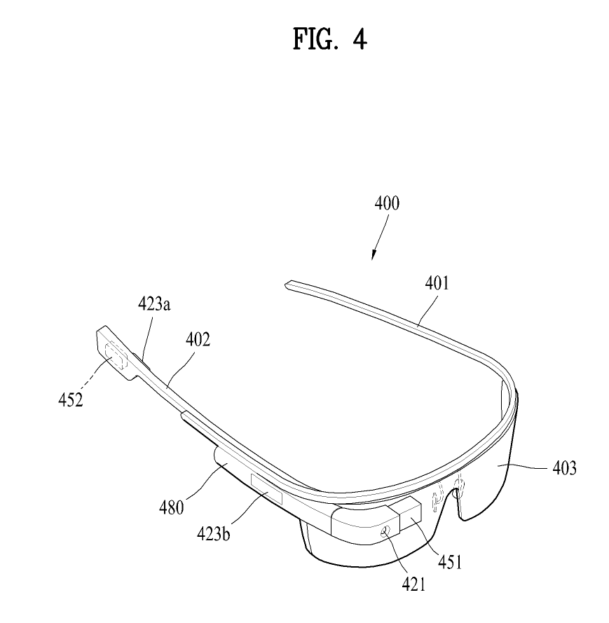

FIG. 4 is a perspective diagram for one example of a glass type mobile terminal 400 related to further embodiment of the present invention.

The glass type mobile terminal 400 is configured wearable on a head of a human body. To this end, the glass type mobile terminal 400 may include a frame unit (e.g., a case, a housing, etc.). The frame unit may be formed of a flexible material to be easily wearable. According to the example shown in the drawing, the frame unit of the mobile terminal 400 includes a 1^{st} frame 401 and a 2^{nd} frame 402, each of which can be made of a different material. In general, the mobile terminal 400 may have the same or similar features of the former mobile terminal 100 shown in FIGS. 1A to 1C.

The frame unit may be supported by the head and provides a space for mounting various components therein. As illustrated, electronic components such as a control module 480, an audio output unit 452 and the like may be installed in the frame unit. And, a lens 403 configured to cover at least one of the left and the right eye may be detachably installed in the frame unit.

The control module 480 is configured to control various electronic components provided to the mobile terminal 400. It may be appreciated that the control module 480 has the configuration corresponding to the aforementioned controller 180. According to the example shown in the present drawing, the control module 480 is installed in the frame unit on one side of the head, by which a location of the control module 480 is non-limited.

The display unit 451 may be embodied into a head mounted display (HMD). The HMD refers to a display system for directly projecting an image in front of user's eyes in a manner of being mounted on the head. In order to provide an image directly in front of the user's eyes, when the user wears the glass type mobile terminal 400, the display unit 451 may be disposed to correspond to at least one of the left eye and the right eye. According to the example shown in the present drawing, the display unit 451 is situated at a location corresponding to the right eye in order to output an image toward the user's right eye.

The display unit 451 may project an image into the user's eye using a prism. And, the prism may be formed to be optically transparent so that the user can watch the projected image and a general visual field (i.e., a range viewed by a user through the corresponding eye) in front of the user.

Thus, the image outputted through the display unit 451 may be viewed in a manner of overlapping the general visual field. The mobile terminal 400 can provide AR (Augmented Reality) by overlaying a virtual image on a real image or a background using the property of the display.

The camera 421 may be disposed adjacent to at least one of the left eye and the right eye to photograph an image in front. Since the camera 421 is situated adjacent to the eye, the camera 421 can obtain an image of a scene currently viewed by the user.

According to the example shown in the preset drawing, the camera 421 is provided to the control module 480, by which the present invention is non-limited. Alternatively, the camera 421 may be installed in the frame unit. Alternatively, a plurality of cameras may be provided to obtain stereoscopic images.

The glass type mobile terminal 400 may include user input units 423a and 423b manipulated to receive an input of a control command. The user input units 423a and 423b may employ any manners (e.g., touch, push, etc.) corresponding to a tactile manner in which a user can perform manipulations by experiencing a tactile sense. According to the example shown in the present drawing, the user input units 423a and 423b of the push input manner and the touch input manner are provided to the frame unit and the control module 480, respectively.

Moreover, the mobile terminal 400 may further include a microphone (not shown in the drawing) for receiving an input of a sound and then processing the input sound into electric audio data and an audio output module 452 for outputting audio. The audio output module 452 may be configured to transfer audio in a general audio output manner or an osteoconductive manner. In case that the audio output unit 452 is embodied in the osteoconductive manner, when the user wears the mobile terminal 400, the audio output unit 452 comes in close contact with a user's head and vibrates user's skull to transfer audio.

A communication system that can be embodied through the mobile terminal 100 according to the present invention is described in detail as follows.

First of all, a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

For clarity, the following description is limited to CDMA only. Yet, it is apparent that the present invention applies equally to other system types including not only CDMA wireless communication system but also OFDM (Orthogonal Frequency Division Multiplexing) wireless communication system.

The CDMA wireless communication system generally includes at least one terminal 100, at least one base station (BS) (possibly named Node B or Evolved Node B), at least one or more base station controllers (BSCs), and a mobile switching center (MSC). The MSC is configured to be connected to a conventional Public Switched Telephone Network (PSTN) and the BSCs. The BSCs are coupled to the base stations to pair with via backhaul line. The backhaul line may be provided in accordance with at least one of EI/TI, ATM, IP, PPP, Frame Relay, HDSL, ADSL, and xDSL. Hence, a plurality of BSCs can be included in the CDMA wireless communication system.

Each of a plurality of BSs (base stations) may include at least one or more sectors. And, each of the sectors may include an omni-directional antenna or an antenna indicating a specific direction radially away from the BS. Alternatively, each of the sectors may include two or more antennas of various types. Each of the BSs may be configured to support a plurality of frequency assignments. And, each of a plurality of the frequency assignments may have a specific spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In this case, the term “base station” may be used to refer collectively to one BSC and at least one BS. The base stations may indicate “cell site.” Moreover, each of a plurality of sectors for a specific BS may be referred to as a plurality of cell sites.

A broadcasting transmitter (BT) transmits a broadcast signal to the mobile terminals 100 operating within the system. The broadcast receiving module 111 shown in FIG. 1A is typically configured inside the mobile terminal 100 to receive broadcast signals transmitted by the BT.

Moreover, Global Positioning System (GPS) for locating the position of the mobile terminal 100 may cooperate with the CDMA wireless communication system. The satellite 300 helps to obtain a location of the mobile terminal 100. Useful position information may be obtained with greater or fewer satellites than two. In doing so, it is able to trace a location of the mobile terminal 100 using all technologies capable of tracing locations or positions as well as the GPS tracking technology. If desired, at least one of the GPS satellites may be in charge of satellite DMB transmissions optionally or additionally.

The location information module 115 provided to the mobile terminal is generally configured to detect, calculate, or otherwise identify a position or location of the mobile terminal. As a representative example, the location information module 115 may include a Global Position System (GPS) module, a Wi-Fi (wireless fidelity) module, or both. If desired, the location information module 115 may alternatively or additionally function as any of the other modules of the wireless communication unit 110 to obtain data related to the position or location of the mobile terminal.

The GPS module 115 accurately calculates current 3D location information according to latitude, longitude and latitude by measuring an accurate time and distance from three or more satellites and then applying trigonometry to the calculated informations. Currently, a method of acquiring distance and time information from three satellites and performing error correction with a single satellite is popularly used. Moreover, the GPS module 115 can acquire speed information by continuing to calculate a real-time current location. Yet, accuracy of a measured location or position of the mobile terminal may be compromised when the mobile terminal is located in such a blind spot of satellite signals as an indoor space or the like. In order to compensate the measured location by GPS system, it is able to use Wi-Fi Positioning System (WPS) and the like.

The Wi-Fi positioning system (WPS) is the location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal 100, a wireless access point (AP) connected to the mobile terminal 100, and a database storing random wireless AP information.

The mobile terminal 100 currently connected to the wireless AP may send a location information request message to the Wi-Fi location determination server.

The Wi-Fi location determination server extracts the information of the wireless AP connected to the mobile terminal 100, based on the location information request message (or signal) of the mobile terminal 100. The information of the wireless AP connected to the mobile terminal 100 may be sent to the Wi-Fi location determination server through the mobile terminal 100, or sent to the Wi-Fi location determination server from the wireless AP.

The information of the wireless AP extracted based on the location information request message of the mobile terminal 100 may include at least one of media access control (MAC) address, service set identification (SSID), received signal strength indicator (RSSI), reference signal received Power (RSRP), reference signal received quality (RSRQ), channel information, privacy, network type, signal strength, noise strength, and the like.

As mentioned in the above description, the Wi-Fi location determination server receives the information of the wireless AP connected to the mobile terminal 100 and may be then able to extract wireless AP information corresponding to the wireless AP connected to the mobile terminal from the pre-established database. In this case, the information of any wireless APs stored in the database may include information such as MAC address, SSID, RSSI, channel information, privacy, network type, latitude and longitude coordinate, building at which the wireless AP is located, floor number, detailed indoor location information (GPS coordinates available), AP owner's address, phone number, and the like. In doing so, in order to remove a mobile AP or a wireless AP provided using an illegal MAC address in the course of a location determining process, the Wi-Fi location determination server may extract only a prescribed number of wireless AP information in order of high RSSI.

Thereafter, the Wi-Fi location determination server may extract (analyze) location information of the mobile terminal 100 using at least one wireless AP information extracted from the database. By comparing the included information and the received wireless AP information to each other, the location information of the mobile terminal 100 is extracted (or analyzed).

As a method for extracting (or analyzing) the location information of the mobile terminal 100, it is able to utilize a Cell-ID scheme, a fingerprint scheme, a trigonometry scheme, a landmark scheme and the like.

The Cell-ID scheme is used to determine a location of a wireless AP having the largest signal strength among peripheral wireless AP information collected by a mobile terminal as a location of the mobile terminal. The Cell-ID scheme has advantages as follows. First of app, Implementation of the Cell-ID scheme is minimally complicated. Secondly, the Cell-ID scheme does not require additional costs. Thirdly, location information can be rapidly acquired. Yet, the Cell-ID scheme has the disadvantage in that the precision of positioning may fall below a desired threshold when the installation density of wireless APs is low.

The fingerprint scheme is a method of estimating a location through a signal strength information transmitted by a mobile terminal based on information collected by selecting a reference location from a service area. In order to use the fingerprint scheme, it is necessary to establish database of propagation characteristics in advance.

The trigonometry scheme is used to calculate a location of a mobile terminal based on a distance between coordinates of at least three wireless APs and the mobile terminal. In order to measure the distances between the mobile terminal and the wireless APs, signal strength may be converted into distance information, or Time of Arrival (ToA), Time Difference of Arrival (TDoA), Angle of Arrival (AoA) and the like may be used.

The landmark scheme is used to measure a location or position of a mobile terminal using a known landmark transmitter.

In addition to the above-listed schemes, various algorithms may be used to extract (or analyze) location information of a mobile terminal.

Such extracted location information may be transmitted to the mobile terminal 100 through the Wi-Fi location determination server, whereby the mobile terminal can acquire the location information.

The mobile terminal 100 can acquire location information by being connected to at least one wireless AP. In doing so, the number of wireless APs required for acquiring the location information of the mobile terminal 100 may be variously changeable depending on a wireless communication environment in which the mobile terminal 100 is situated.

) As mentioned in the foregoing description with reference to FIG. 1A, short-range communication techniques such as Bluetooth™, Radio Frequency Identification (RFID), Infrared Data Association (IrDA), Ultra Wideband (UWB), ZigBee, Near Field Communication (NFC), Wireless USB (Wireless Universal Serial Bus) and the like may apply to the mobile terminal according to the present invention.

Among the short-range communication technologies, NFC module provided to the mobile terminal supports an inter-terminal non-contact type short-range wireless communication in a distance of about 10 cm range. The NFC module may operate in one of a card mode, a reader mode and a P2P mode. The mobile terminal 100 may further include a security module for storing card information in order to for the NFC module in the card mode. In this case, the security module may include one of a physical medium such as Universal Integrated Circuit Card (UICC) (e.g., Subscriber Identification Module (SIM), Universal SIM (USIM), etc.), Secure micro SD, a sticker and the like, or a logical medium (e.g., embedded Secure Element (SE), etc.) embedded in the mobile terminal. Data exchange may be performed between the NFC module and the security module based on Single Wire Protocol (SWP).

In a case that the NFC module operates in the card mode, the mobile terminal may externally transfer card information saved like a traditional IC card.

In particular, if a mobile terminal storing card information of a payment card (e.g., a credit card, a bus card, etc.) approaches a card reader, a short-range mobile payment may be processed. If a mobile terminal storing card information of an entrance card approaches an entrance card reader, an entrance approval procedure may start. A card such as a credit card, a traffic card, or an entrance card may be loaded on the security module in the form of applet, and the security module may store card information on the loaded card. In this case, the card information of the payment card may include at least one of a card number, a remaining amount, a use history, and the like.

The card information of the entrance card may include at least one of a user's name, a user's number (e.g., a user's student number, a user's staff number, etc.), an entrance history, and the like.

In case that the NFC module operates in the reader mode, the mobile terminal can read data from an external tag. In doing so, the data received from the external tag by the mobile terminal may be coded in NFC Data Exchange Format defined by NFC Forum. And, the NFC Forum generally defines four record types. In particular, the NFC Forum defines four Record Type Definitions (RTDs) such as Smart Poster, Text, Uniform Resource Identifier (URI), General Control and the like. If the data received from the external tag is a smart poster type, the controller can run a browser (e.g., Internet browser, etc.). If the data received from the external tag is a text type, the controller can run a text viewer. If the data received from the external tag is a URI type, the controller can run a browser or make a phone call. If the data received from the external tag is a general control type, the controller can execute an accurate operation in accordance with control contents.

In case that the NFC module operates in the P2P (Peer-to-Peer) mode, the mobile terminal can perform P2P communication with another mobile terminal. In this case, Logical Link Control Protocol (LLCP) can apply to the P2P communication. For the P2P communication, connection may be created between one mobile terminal and another mobile terminal. In this case, the connection may be categorized into a connectionless mode terminated after switching a single packet or a connection-oriented mode for exchanging packets consecutively. Through the P2P communication, data such as an electronic type business card, contact information, a digital photo, a URL and the like, setup parameters for Bluetooth connection, Wi-Fi connection, etc. can be exchanged. Yet, the P2P mode can be effectively utilized in exchanging data in small size because an available distance for the NFC communication is relatively short.

Embodiments related to a controlling method implemented in the above-configured mobile terminal shall be described in more detail with reference to the accompanying drawings. It is understood by those skilled in the art that the present features can be embodied in several forms without departing from the characteristics thereof.

In the following description, embodiments of the present specification shall be described by taking the mobile terminal 100 shown in FIG. 1A as one example. Yet, it is a matter of course that a mobile terminal according to one embodiment of the present invention can be embodied with the mobile terminals 200, 300 and 400 shown in FIGS. 2 to 4.

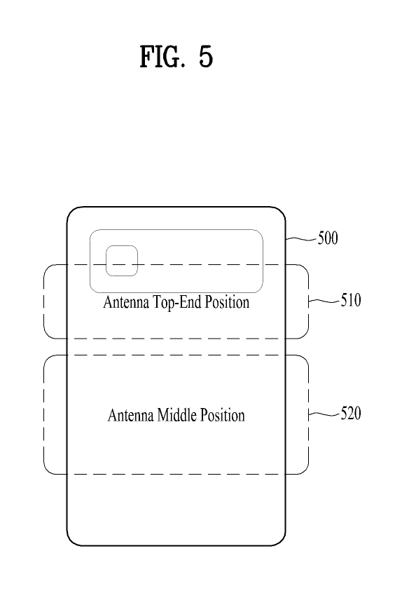

FIG. 5 illustrates an exemplary area of a mobile device in which an antenna for mobile payment is disposed.

As illustrated in FIG. 5, an NFC antenna/coil for mobile payment is positioned in a first area 510, and an MST antenna/coil for mobile payment is positioned in a second area 520, in a mobile device 500.

Further, terminals and devices differ in an area (position) for NFC mobile payment or MST mobile payment. Even products of the same manufacturer have different antenna (coil) positions for mobile payment. An antenna position for wireless charging is also different in each device.

Accordingly, when a mobile payment is to be made with a mobile device, what part of the mobile device should contact a POS terminal in a shop is not known, thereby causing a long time delay in the mobile payment. In fact, it is not possible for all users to memorize the position of an NFC antenna or MST antenna in their mobile devices.

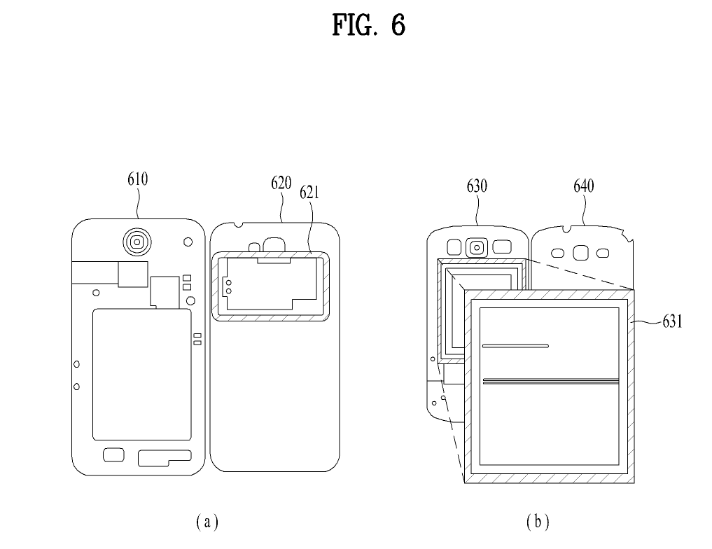

FIG. 6 illustrates another exemplary area of a mobile device in which an antenna for mobile payment is disposed. While FIG. 5 schematically illustrates the positions of antennas for mobile payment, FIG. 6 illustrates the position of an antenna for mobile payment in detail.

As illustrated in (a) of FIG. 6, a mobile device 610 is designed such that an NFC or MST antenna for mobile payment is positioned at a top end of a cover 620, instead of a body. 1228) Meanwhile, a metal portable phone has recently been developed. In view of the nature of metal, it is difficult to dispose an NFC antenna for mobile payment at the center of the rear cover of a mobile device. Therefore, as illustrated in (a) of FIG. 6, the NFC antenna is positioned in an upper part of the rear cover in many cases.

Meanwhile, as illustrated in (b) of FIG. 6, another mobile device 630 has an NFC antenna inserted in a battery 631. Further, some mobile device has an NFC antenna inserted in a space other than the battery 631.

That is, as described in detail with reference to FIGS. 5 and 6, the position of an NFC antenna or an MST antenna is different on a manufacturer basis or on a model basis. As a result, a mobile payment is not actively made and much time is taken for a mobile payment.

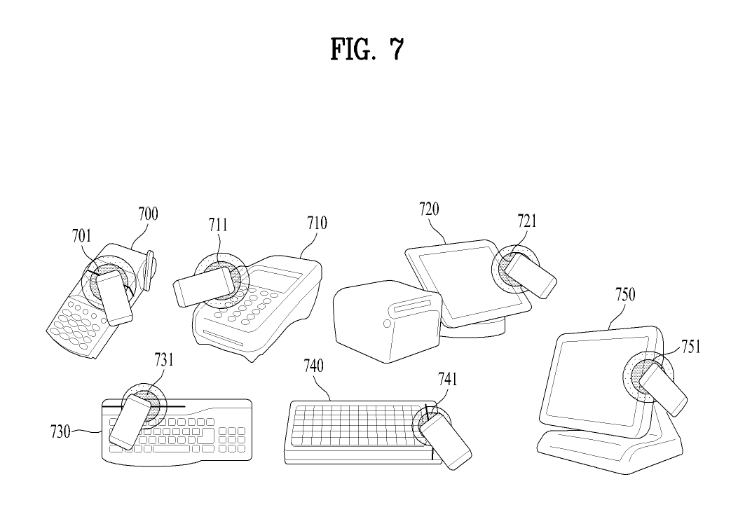

FIG. 7 illustrates specific areas of POS terminals in which a credit card or an MST-enabled mobile device can be recognized.

To make a mobile payment by NFC, each business place should install a POS terminal capable of NFC payment. However, a mobile payment may still be made on a conventional POS terminal (capable of card payment) by MST.

However, as illustrated in FIG. 7, there are a large number of types of POS terminals which enable MST payment with a credit card or a mobile device, and each POS terminal reads magnetic information in a different area thereof. Although it does not matter with a credit card, none of a user and a sales person may know a part of a conventional POS terminal to contact with an MST-enabled mobile device because the mobile device contacts the POS terminal rather than it is swiped on the POS terminal.

For example, only when an MST payment-enabled mobile device is recognized in a specific top area 701 of the front surface of a first POS terminal 700, a payment is made on the first POS terminal 700. A payment is made on a second POS terminal 710, only when an MST payment-enabled mobile device is recognized in a specific left area 711 of the front surface of the second POS terminal 710.

For example, only when a third POS terminal 720 recognizes an MST payment-enabled mobile device in a specific right area 721 of the front surface thereof, a payment may be made. Only when a fourth POS terminal 730 recognizes an MST payment-enabled mobile device in a specific top left area 731 of the front surface thereof, a payment may be made. A sixth POS terminal 750 is designed such that only when an MST payment-enabled mobile device is recognized in a specific right area 75I of the front surface thereof, a payment is made. Even though a conventional POS terminal is capable of making a payment with an MST payment-enabled mobile device, the conventional POS terminal fails in payment because it is not known which area of the mobile device should contact which area of the POS terminal. As a consequence, a user may mistake the payment failure for a payment impossible situation.

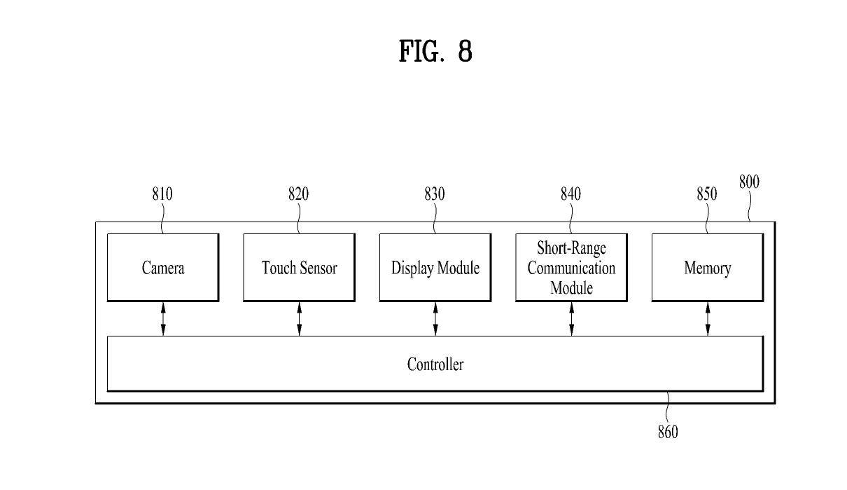

Various embodiments for solving the conventional problem described with reference to FIGS. 5 to 7 will be described in detail with reference to FIG. 8 and its subsequent drawings.

FIG. 8 illustrates a mobile device equipped with a mobile payment function according to an embodiment of the present disclosure.

A mobile device 800 according to an embodiment of the present disclosure includes a camera 810, a touch sensor 820, a display module 830, a short-range communication module 840, a memory 850 that stores information about at least one card capable of paying for an item, and a controller 860 that controls the touch sensor 820, the display module 830, and the memory 850. The information about at least one card capable of paying for an item includes, for example, information about a virtual credit card, which is stored in the memory by default or downloaded through a bank-related application or a Web site. As far as it includes payment-enabling information (e.g., a card number, a password, and so on), any information is available without limitations. Meanwhile, more specifically, the payment is made by, for example, NFC or MST.

Particularly, the controller 860 characteristically controls the display module 830 to display a predetermined area from which card information stored in the memory 850 may be read, distinctly from other areas, in response to a command for executing a payment function.

Characteristically, the specific area overlaps with, for example, at least one of the position of an NFC chip or the position of an MST chip. The chip includes an antenna or coil.

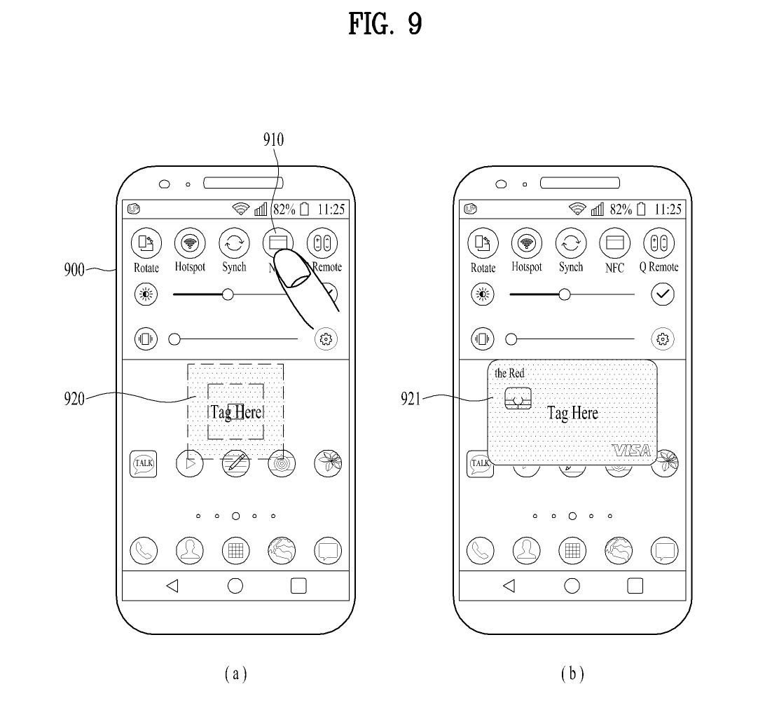

The command for executing the payment function includes, for example, a command that turns on an NFC function, which will be described later in detail with reference to FIG. 9.

Characteristically, if an NFC write mode is set, a virtual card is displayed in the specific area, and if an NFC read mode is set, a non-virtual card is displayed in the specific area, which will be described later in detail with reference to FIG. 9.

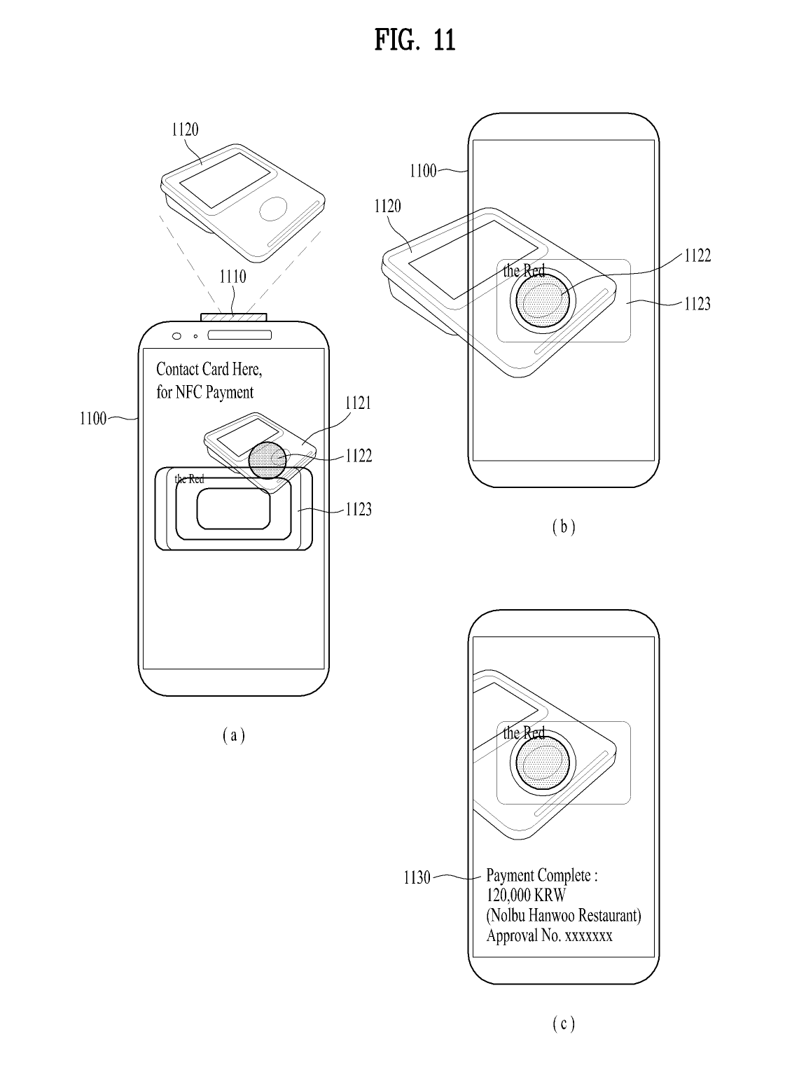

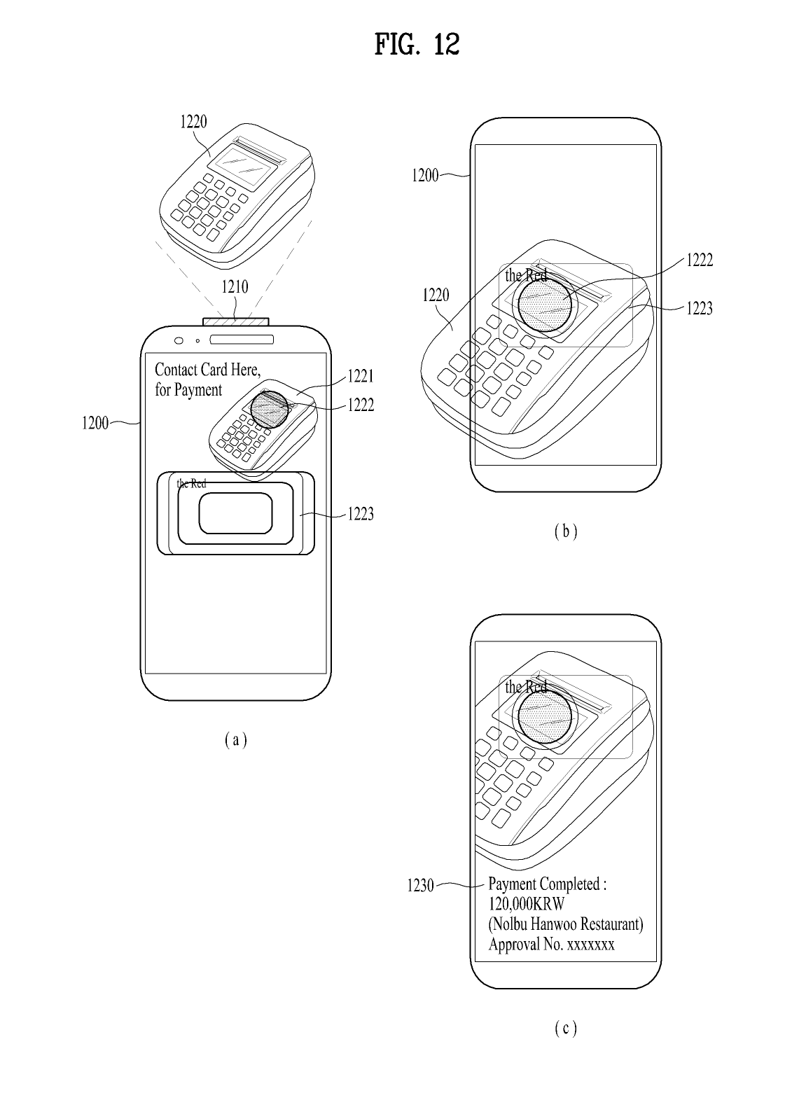

Characteristically, the camera 810 captures an external POS terminal, and the controller 860 recognizes the type of the captured POS terminal, referring to the memory 850. Further, the display module 830 displays the captured POS terminal, and additionally displays a specific area of the POS terminal, in which card information stored in the memory 850 of the mobile device can be read, according to the recognized type, which will be described later in detail with reference to FIGS. 11 and 12.

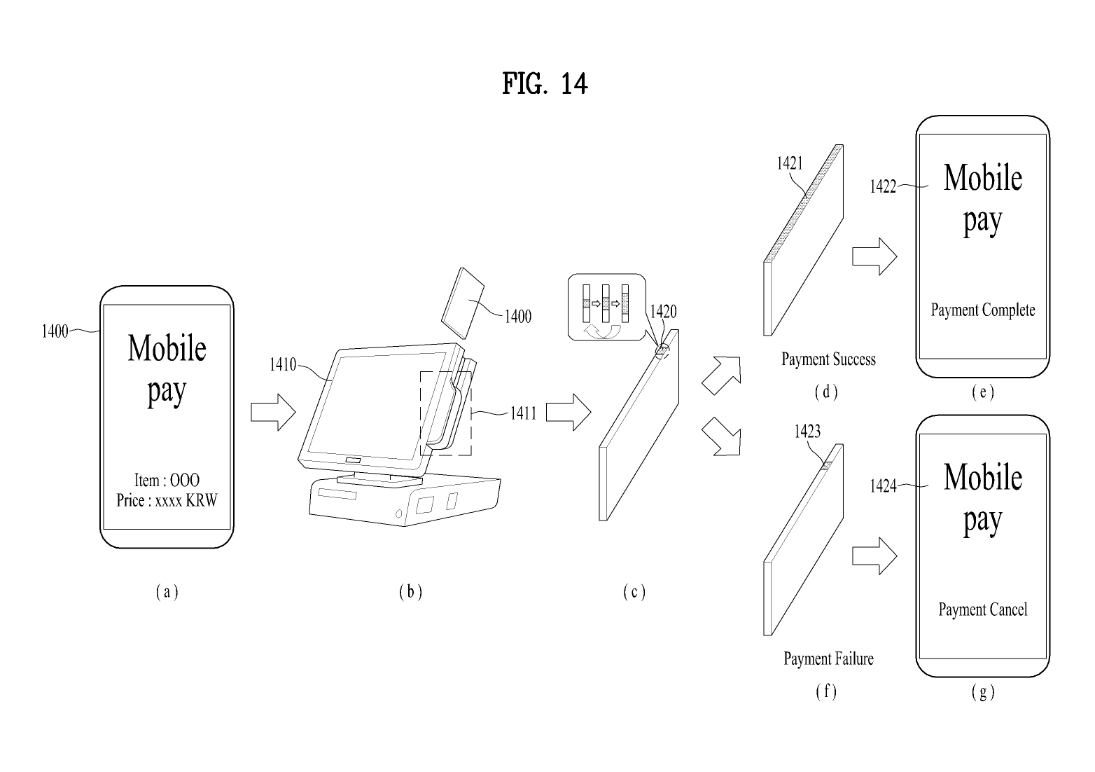

The mobile device 800 may be designed so as to further include a side display module. If recognizing that the posture of the mobile device 800 has been changed, through a motion sensor (not shown), the controller 860 controls the side display module to display a predetermined specific area in which card information stored in the memory 850 can be read, which will be described later in more detail with reference to FIG. 14 so that a person skilled in the art may implement the operation.

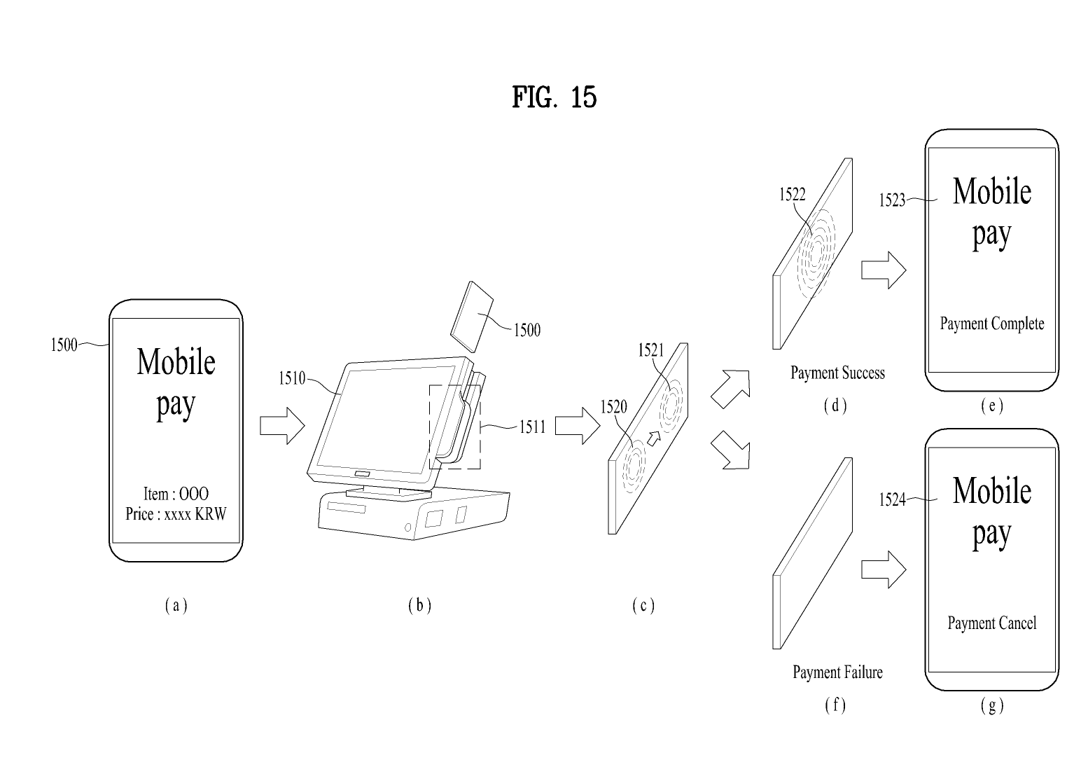

Meanwhile, the mobile device 800 may be designed so as to further include at least one vibration sensor. If recognizing that the posture of the mobile device 900 has been changed, through the motion sensor (not shown), the controller 860 controls the vibration sensor to vibrate a predetermined specific area in which card information stored in the memory 850 can be read, which will be described later in more detail with reference to FIG. 15 so that a person skilled in the art may implement the operation.

FIG. 9 illustrates an example of starting a payment function by using a mobile device according to an embodiment of the present disclosure.

NFC is a short-range information communication technology. In NFC, various data are wirelessly transmitted and received at a short distance within about 10 cm. For example, if a smartphone is tapped against an NFC tag or terminal, the smartphone is capable of reading data stored in the NFC tag or terminal.

Further, NFC modes include, for example, peer-to-peer mode, reader/writer mode, card emulation mode, and so on

If the NFC card emulation mode (or write mode) is set, a virtual card is displayed in a specific area of the mobile device. Meanwhile, if a mode (NFC read mode) other than the NFC emulation mode is set, a non-virtual mode is displayed in the specific area of the mobile device.

More specifically, for example, if an option 910 to activate NFC is selected, a mobile device 900 displays a position 920 to be tapped against an NFC tag or device, as illustrated in (a) of FIG. 9. Herein, the card emulation mode is not set.

On the contrary, if the card emulation mode is set, a virtual card 921 is displayed in an NFC sensing area, to thereby guide to safe mobile payment, as illustrated in (b) of FIG. 9. It is obvious that indicating the display position of the virtual card 921 with another mark or flickering the display position of the virtual card 921, without displaying the virtual card 921 also falls within the scope of the present disclosure.

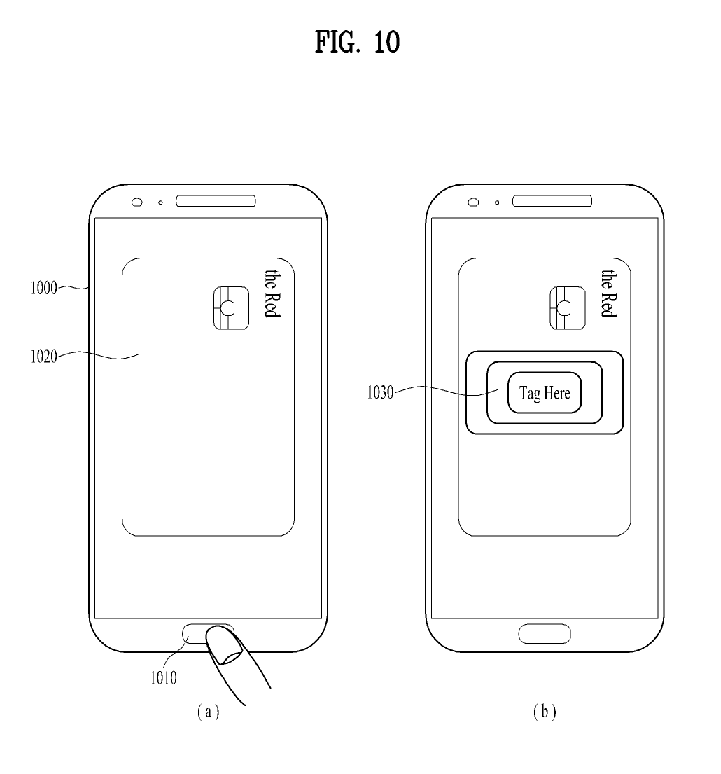

FIG. 10 illustrates another example of starting a payment function by using a mobile device according to an embodiment of the present disclosure. It may not be determined accurately just from selection of an NFC option whether a user intends to make a mobile payment. A solution to the problem is illustrated in FIG. 10.

It is assumed that a mobile device is in an MFC communication-enabled state, or is capable of MST payment. As illustrated in (a) of FIG. 10, upon selection of a specific area 1010 (e.g., a fingerprint sensing area) in a mobile device 1000, a virtual card stored in a memory is displayed.

Further, as illustrated in (b) of FIG. 10, the mobile device is designed so as to display a specific area 1030 which guides to the position of an NFC antenna or an MST antenna. Thus, when a mobile payment is made, a user is guided to accurately tap the specific area 1030 of the mobile device against a corresponding POS terminal.

However, although a specific area of a mobile device in which a mobile payment is possible may be indicated in the foregoing embodiment illustrated in FIGS. 9 and 10, the problem is expected that a part of a POS terminal to be tapped on is not known. A solution to the problem will be described later with reference to FIGS. 11 and 12. Particularly, FIG. 11 illustrates a process of making a mobile payment by NFC, and FIG. 12 illustrates a process of making a mobile payment by MST.

FIG. 1 illustrates a process of making a payment on an NFC payment-enabled POS terminal with a mobile device according to an embodiment of the present disclosure.

If a mobile payment is executed or an NFC option is turned on, a mobile device 1100 according to an embodiment of the present disclosure automatically activates a camera 1110. Further, the camera 1110 captures a nearby POS terminal 1120, and displays a captured image 1121 of the POS terminal 1120, particularly highlighting a specific area 1122 requiring NFC tapping in the image 1121. Meanwhile, two embodiments are available for detecting a specific NFC tapping area of a POS terminal by the mobile device 1100.

In one embodiment, the mobile device may directly receive product type information from the POS terminal 1120 by wireless communication, and determine a specific area requiring NFC tapping on the basis of the product type information.

In the other embodiment, if the POS terminal 1120 is not capable of transmitting product type information, the mobile device 1100 may estimate the type of the POS terminal 1120 by analyzing an image that the mobile device has captured through the camera 1110.

Meanwhile, the mobile device 1100 according to an embodiment of the present disclosure displays an area 1123 in which an NFC antenna/coil is positioned. The area 1123 is recognized as an area to be tapped on the POS terminal.

Therefore, as illustrated in (b) of FIG. 11, a user may pay fast by tapping a first area 1123 with the NFC antenna/coil of the mobile device 1100 on a specific second area of the POS terminal 1120. Obviously, the present disclosure is also applicable to a mobile device having a transparent display.

If the mobile device moves so that the first area 1123 matches the second area 1122, a guide message 1130 indicating successful completion of the payment is displayed, as illustrated in (c) of FIG. 11.

FIG. 12 illustrates a process of making a payment with a mobile phone on an MST payment-enabled POS terminal according to an embodiment of the present disclosure.

If a mobile payment is executed, a mobile device 1200 according to an embodiment of the present disclosure automatically activates the function of a camera 1210. Further, the camera 1210 captures a nearby POS terminal 1220, and displays a captured image 1221 of the POS terminal 1220, particularly, highlighting a specific area 1222 requiring MST tapping in the image 1221. Meanwhile, two embodiments are available for detecting a specific MST tapping area of a POS terminal by the mobile device 1200.

In one embodiment, the mobile device may directly receive product type information from the POS terminal 1220 by wireless communication, and determine a specific area requiring MST tapping on the basis of the product type information.

In the other embodiment, if the POS terminal 1220 is not capable of transmitting product type information, the mobile device 1200 may estimate the type of the POS terminal 1220 by analyzing an image that the mobile device 1200 has captured through the camera 1210.

Meanwhile, the mobile device 1200 according to an embodiment of the disclosure displays an area 1223 in which an MST antenna/coil is positioned. The area 1223 is recognized as an area to be tapped on the POS terminal.

Therefore, as illustrated in (b) of FIG. 12, a user may pay fast by tapping a first area 1223 in which the MST antenna/coil of the mobile device 1200 is positioned on a specific second area 1222 of the POS terminal 1220. Obviously, the present disclosure is also applicable to a mobile device having a transparent display.

If the mobile device moves so that the first area 1223 matches the second area 1222, a guide message 1230 indicating successful completion of the payment is displayed, as illustrated in (c) of FIG. 12.

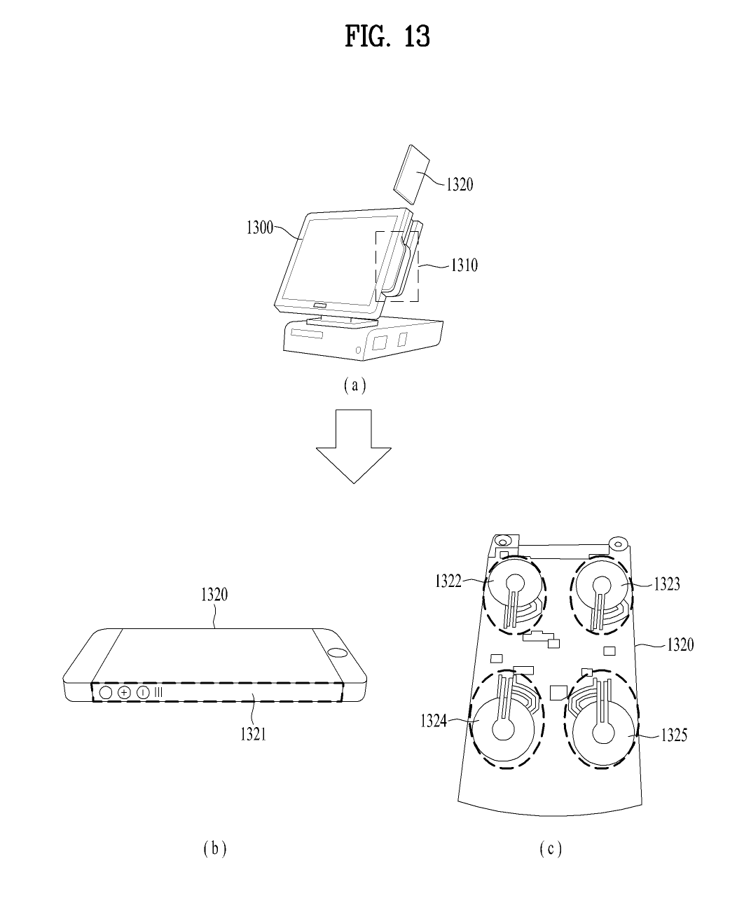

Meanwhile, in view of the structure of an NFC-enabled POS terminal, it seldom occurs that payment is to be made by standing a mobile device sideways. On the contrary, a conventional MST-enabled POS terminal requires sideways erection of a mobile device according to the type (structure) of the mobile device. In this case, it is not easy to check a tapping position on the front display of the mobile device. A solution to the problem will be described below with reference to FIGS. 13, 14, and 15.

FIG. 13 illustrates a situation in which a payment function should be executed through a solution other than its front display according to an embodiment of the present disclosure.

When a mobile payment is made or wireless charging is performed, a user has difficulty in viewing the front display of a mobile device according to the structure of a POS terminal or a wireless charging pad in some cases, for example, as is the case where a (NFC or MST) contact surface of a POS terminal is on a side of the POS terminal or the user places the mobile device on a wireless charging cradle (or pad), lying down in a bed.

More specifically, for example, if a magnetic information reading part is positioned on a side surface 1310 of a POS terminal 1300, a mobile device 1320 should be made stand up. Then, it is typically difficult for a user to view the front display of the mobile device 1320.

However, if the mobile device 1320 according to another embodiment of the disclosure is provided with a side display 1321 as illustrated in FIG. 13(b), a charging position or the position of an antenna for mobile payment may be displayed in a specific area of the side display 1321. For example, the position of an NFC or MST antenna is displayed by a graphical effect such as a narrow strip, which will be described below in detail with reference to FIG. 14.

Meanwhile, if the mobile device 1320 according to another embodiment of the disclosure includes a plurality of vibration motors 1322, 1323, 1324, and 1325 as illustrated in (c) of FIG. 13, vibrations may be generated at a specific payment-enabling position of the mobile device by controlling strength and time differences between the motors, which will be described below in detail with reference to FIG. 15.

FIG. 14 illustrates a process of executing the payment function by using a side display of a mobile device in order to solve the problem illustrated in FIG. 13.

As illustrated in (a) of FIG. 14, it is assumed that a mobile device 1400 according to an embodiment of the disclosure executes a mobile payment function.

As illustrated in (b) of FIG. 14, if an MST or NFC tapping area 1411 is on a side surface of a POS terminal 1410, the mobile device 1400 should be turned sideways. A motion sensor (e.g., a gyro sensor) of the mobile device 1400 senses this situation (detects the sideway-lying state), and the front display of the mobile device 1400 is turned off. Further, as illustrated in (c) of FIG. 14, the position of an NFC or MTS antenna/coil is displayed on a side display 1420. For example, the position may be indicated by a narrow blue strip. Further, one of the features of the present disclosure is to design the area 1420 illustrated in FIG. (c) of 14 to change periodically (wide->narrow->wide).

If a payment is made within a predetermined time (e.g., 15 seconds) (i.e., the position of the NFC or MST antenna of the mobile device matches the tapping area of the POS terminal), the whole side display area 1421 is illuminated in a specific color (e.g., blue), as illustrated in (d) of FIG. 14.

As illustrated in (e) of FIG. 14, a message 1422 indicating successful completion of the payment is displayed.

On the other hand, if the payment is not made within the predetermined time (e.g., 15 seconds) (i.e., the position of the NFC or MST antenna of the mobile device does not match the tapping area of the POS terminal), only a specific area 1423 of the side display is illuminated in a specific color (e.g., red), as illustrated in (f) of FIG. 14.

As illustrated in (g) of FIG. 14, a message 1424 indicating payment failure is displayed. Meanwhile, if the mobile device is rotated to a normal state after the operation of (d) or (f) of FIG. 14, the front display is automatically switched to an on state.

FIG. 15 illustrates a process of executing the payment function by a haptic operation of a mobile device in order to solve the problem illustrated in FIG. 13.

As illustrated in (a) of FIG. 15, it is assumed that a mobile device 1500 according to an embodiment of the disclosure executes a mobile payment function.

As illustrated in (b) of FIG. 15, if an MST or NFC tapping area 1511 is on a side surface of a POS terminal 1510, the mobile device 1500 should be turned sideways. A motion sensor (e.g., a gyro sensor) of the mobile device 1500 senses this situation (detects the sideway-lying state), and the front display of the mobile device 1500 is turned off. Further, as illustrated in (c) of FIG. 15, the position of an NFC or MTS antenna/coil is indicated by vibration sensors 1520 and 1521.

If a payment is made within a predetermined time (e.g., 15 seconds) (i.e., the position of the NFC or MST antenna of the mobile device matches the tapping area of the POS terminal), all actuators 1522 vibrate strongly at the same time, as illustrated in (d) of FIG. 15.

As illustrated in (e) of FIG. 15, a guide message 1523 indicating successful completion of the payment is displayed.

On the other hand, if the payment is not made within the predetermined time (e.g., 15 seconds) (i.e., the position of the NFC or MST antenna of the mobile device does not match the tapping area of the POS terminal), vibrations are discontinued, as illustrated in (f) of FIG. 15.

As illustrated in (g) of FIG. 15, a guide message 1524 indicating payment failure is displayed. Meanwhile, if the mobile device is rotated to the normal state after the operation of (d) or (f) of FIG. 15, the front display is automatically switched to the on state.

Therefore, the design illustrated in FIG. 14 or FIG. 15 brings about the technical effect that energy loss caused by unnecessary use of the front display is prevented.

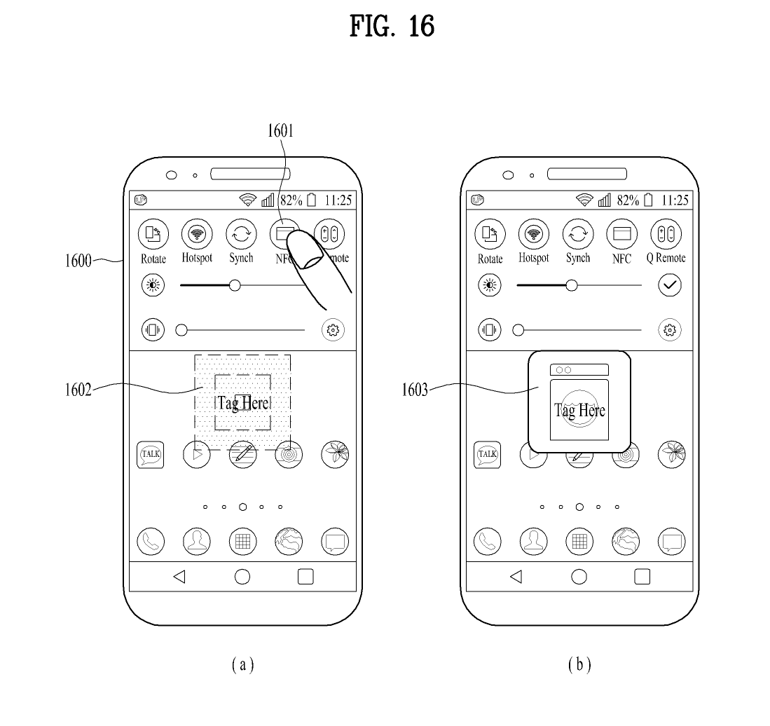

FIG. 16 illustrates a case in which a mobile device is applied to IoT control, instead of mobile payment according to an embodiment of the present disclosure.

With reference to up to FIG. 15, application of the present disclosure mainly to mobile payment has been described. The present disclosure is also applicable to an IoT control environment, instead of mobile payment, as illustrated in FIG. 16.

As illustrated in (a) of FIG. 16, upon selection of an NFC option 1601, a mobile device 1600 according to an embodiment of the present disclosure displays the position 1602 of an NFC antenna/coil.

As illustrated in (b) of FIG. 16, the mobile device according to an embodiment of the disclosure is designed so as to display, at the position of the NFC antenna/coil, a graphic image 1603 representing an IoT product against which the mobile device can be tapped at a current position. Therefore, the technical effect of guiding to fast NFC communication between the mobile device and the IoT product is achieved.

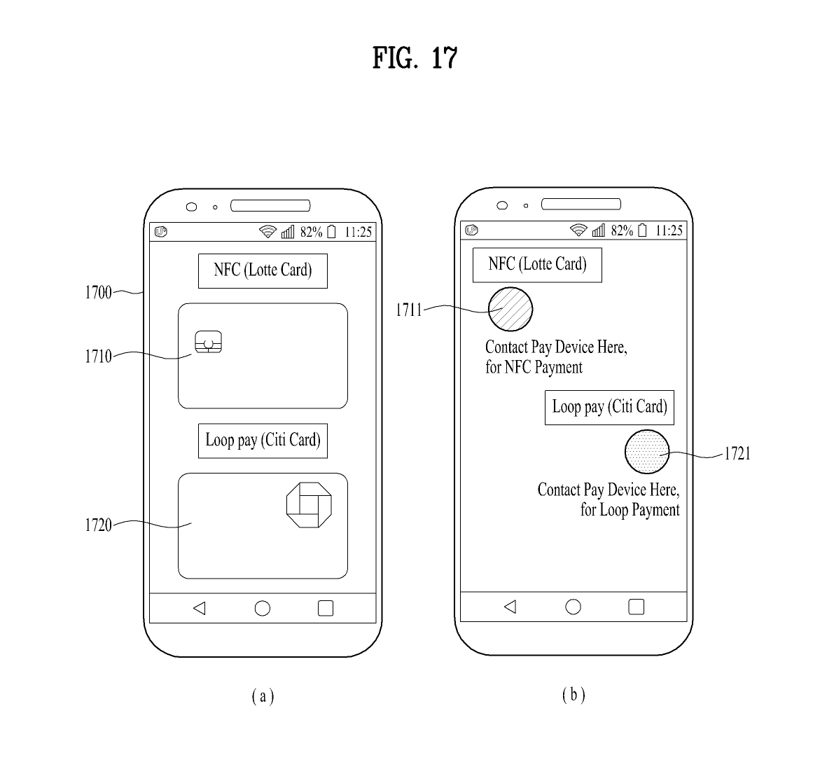

FIG. 17 illustrates an embodiment of a graphical user interface (GUI) used during mobile payment in a mobile device according to an embodiment of the present disclosure.

As illustrated in (a) of FIG. 17, if a mobile device 1700 according to an embodiment of the disclosure enters a payment mode (e.g., if an NFC option is turned on or a fingerprint for mobile payment is recognized), first card information 1710 and second card information 1720 stored in a memory are displayed.

Further, as illustrated in (b) of FIG. 17, it is designed that the first card information is displayed at the position 1711 of an NFC antenna/coil, and the second card information is displayed at the position 1721 of an MST antenna/coil. That is, a payment can be made with the first card information only by NFC, and a payment can be made with the second card information only by MST. The opposite case also falls within the scope of the present disclosure.

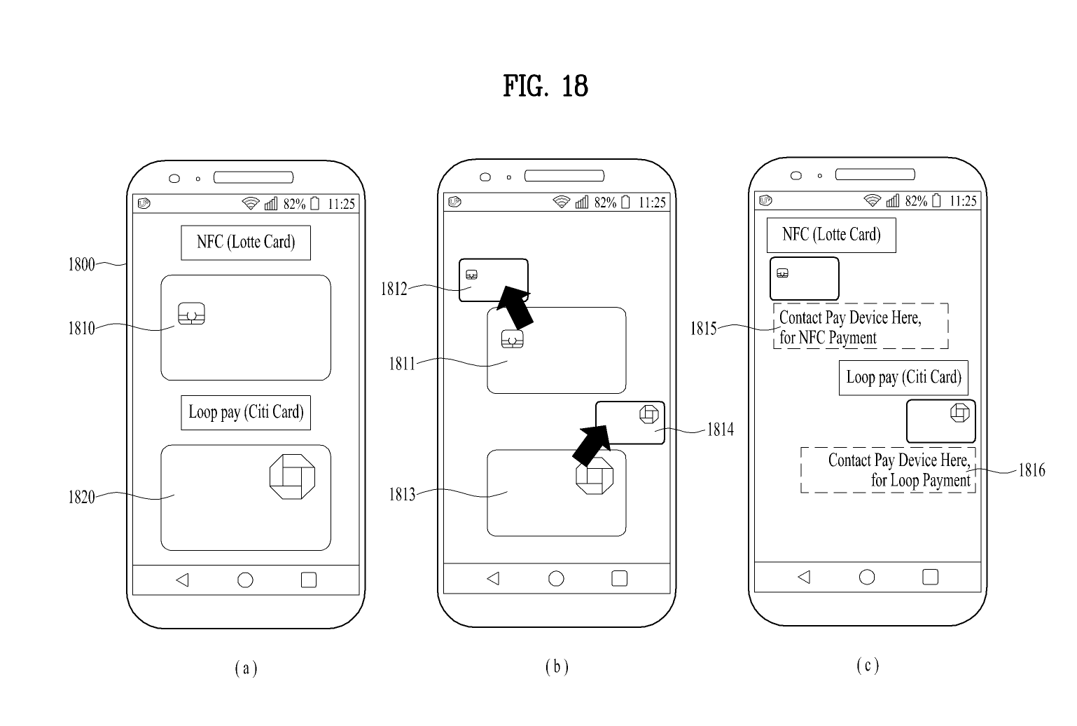

FIG. 18 illustrates another embodiment of a GUI used during mobile payment in a mobile device according to an embodiment of the present disclosure.

As illustrated in (a) of FIG. 18, if a mobile device 1800 according to an embodiment of the disclosure enters the payment mode (e.g., if an NFC option is turned on or a fingerprint for mobile payment is recognized), first card information 1810 and second card information 1820 stored in a memory are displayed.

Unlike FIG. 17 described before, as illustrated in (b) of FIG. 18, an animation effect of movement from an initial position 1811 to the position 1812 of an NFC antenna/coil is additionally provided to the first card information, and an animation effect of movement from an initial position 1813 to the position 1814 of an MST antenna/coil is additionally provided to the second card information.

Further, as the first card information displays a first guide message 1815 indicating NFC payment, and the second card information displays a second guide message 1816 indicating MST payment, the technical effect of preventing a user from attempting to pay on a wrong POS terminal can be achieved. Obviously, the opposite case also falls within the scope of the present disclosure.

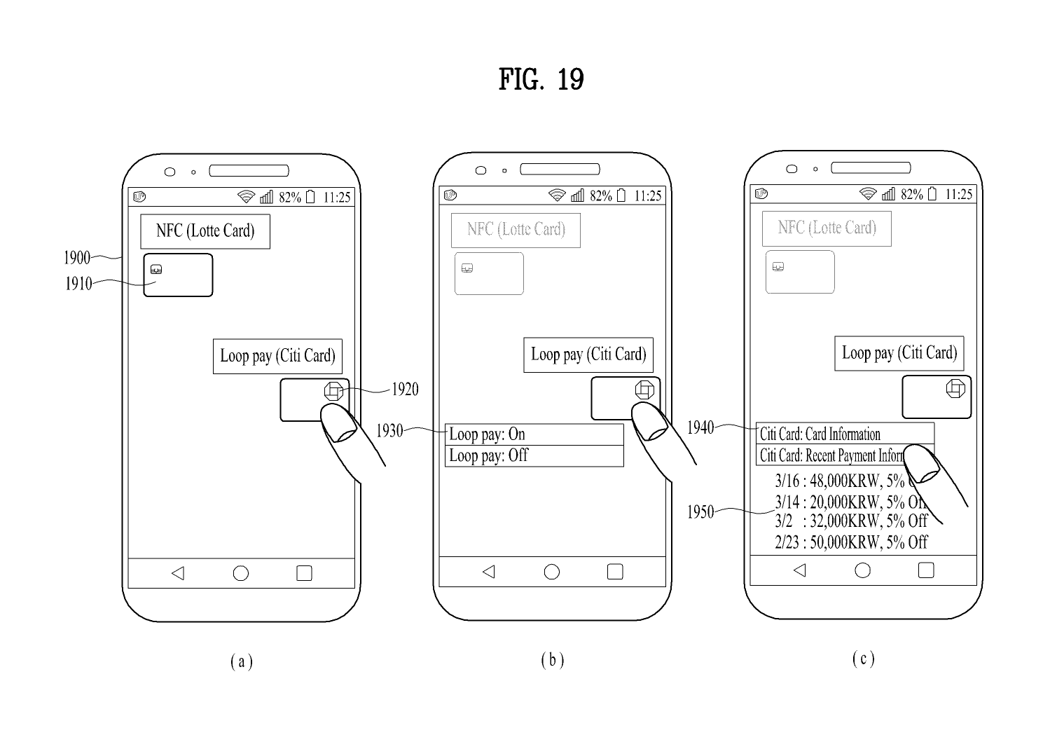

FIG. 19 illustrates a third embodiment of a GUI used during mobile payment in a mobile device according to an embodiment of the present disclosure. Based on the foregoing description of FIG. 17 or FIG. 18, the third embodiment illustrated in FIG. 19 will be described.

As illustrated in (a) of FIG. 19, a mobile device 1900 according to an embodiment of the disclosure displays first card information 1910 enabling NFC payment at the position of an NFC antenna/coil, and second card information 1920 enabling MST payment at the position of an MST antenna/coil.

Further, upon selection of the second card information 1920 illustrated in (a) of FIG. 19, the unselected first card information disappears, and an option 1930 to activate MST payment is displayed, as illustrated in (b) of FIG. 18. Loop pay in FIG. 19 corresponds to MST payment.

Further, as illustrated in (c) of FIG. 19, it is designed that upon selection of recent payment information 1940, details 1950 of payments which have recently been made with a corresponding card are additionally displayed. The concept of “recent” may be configured by a user or may be a month from a current date.

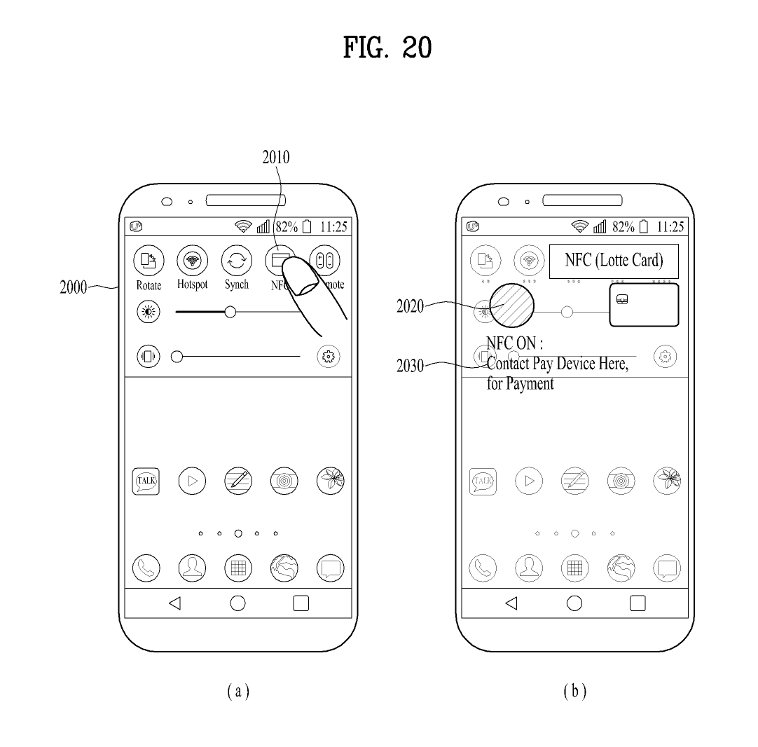

FIG. 20 illustrates a fourth embodiment of a GUI used during mobile payment in a mobile device according to an embodiment of the present disclosure.

Upon selection of an NFC option 2010 as illustrated in (a) of FIG. 20, an optimum position 2020 for NFC payment and a guide message 2030 are displayed for a predetermined time (e.g., 5 seconds) and then disappear in a mobile device 2000 according to an embodiment of the disclosure as illustrated in (b) of FIG. 20. Therefore, it advantageously helps a user to learn mobile payment.

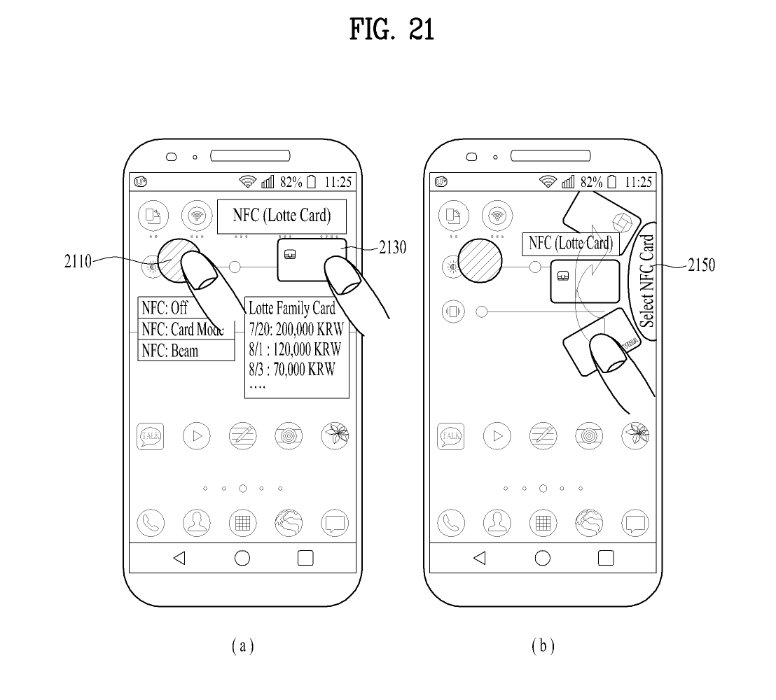

FIG. 21 illustrates a fifth embodiment of a GUI used during mobile payment in a mobile device according to an embodiment of the present disclosure.

As illustrated in (a) of FIG. 21, a mobile device according to an embodiment of the disclosure displays an optimum position for NFC payment (e.g., the position of an NFC antenna/coil) in a first area 2110, an option to select NFC on/off and modes in a second area 2120, a representative image of an NFC payment-enabled card in a third area 2130, and upon selection of the third area 2130, displays details of payments made with the selected card in a fourth area 2140. Obviously, displaying only one of the first to fourth areas also falls within the scope of the disclosure.

Further, an option 2150 to select one of a plurality of NFC payment-enabled cards is displayed, as illustrated in (b) of FIG. 21. More specifically, for example, if a payment card is dragged up/down or to the left/right, pre-registered payment cards (payment cards stored in a memory) are sequentially displayed, rotating in the dragged direction, as illustrated in (b) of FIG. 21. Herein, if a user selects a desired card, the representative image of the card displayed in the third area 2130 of (a) of FIG. 21 is changed.

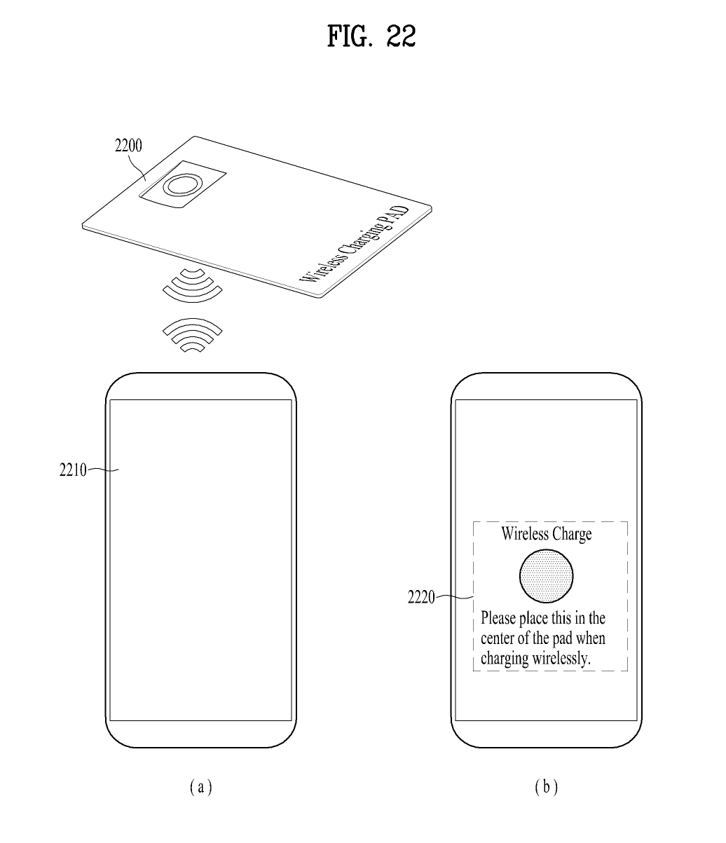

FIG. 22 illustrates a process of performing wireless charging in a mobile device according to another embodiment of the present disclosure.

While mainly mobile payment with a mobile device has been described above with reference to the previous drawings, a detailed description will be given below of a process of performing wireless charging by a mobile device according to another embodiment of the disclosure.

As illustrated in (a) of FIG. 22, if a mobile device 2210 according to another embodiment of the disclosure contacts or recognizes a wireless charging pad 2200, the position 2220 of an antenna for wireless charging is displayed highlighted, as illustrated in (b) of FIG. 22. Therefore, a user may control the position 2220 to be at the center of the wireless charging pad, thereby shortening a time taken for wireless charging.

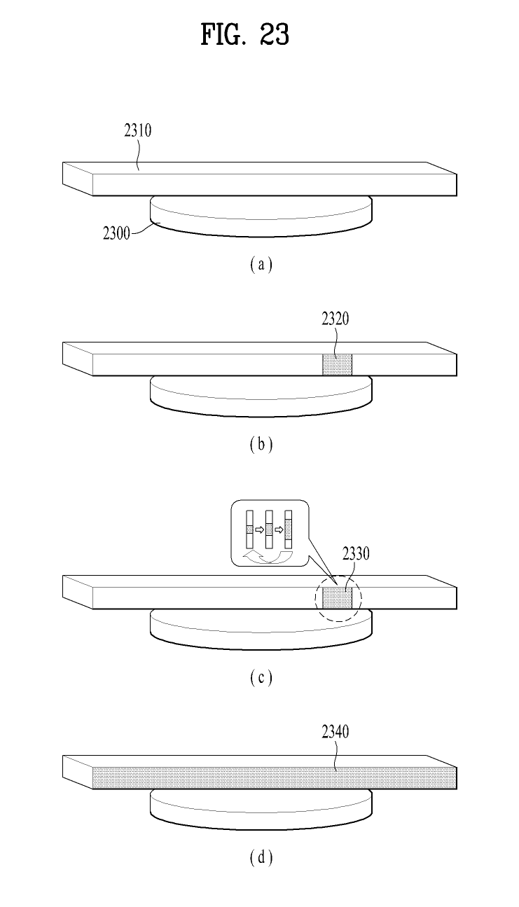

FIG. 23 illustrates a process of performing wireless charging in a mobile device according to another embodiment of the present disclosure.

Like FIG. 22, FIG. 23 is applicable to a wireless charging environment. However, unlike FIG. 22, FIG. 23 is applicable only to a mobile device having an additional side display. Particularly, FIG. 23 enhances a technical effect in the case where a user charges the mobile device, while lying down on the back.

As illustrated in (a) of FIG. 23, the user places a mobile device 2310 on a wireless charger 2300, while lying down on the back. The wireless charger 2300 may be designed to be, for example, a pad.

The mobile device senses the wireless charger through a communication module or the like, and displays the position of a rechargeable battery module in the form of a narrow blue strip 2320 on the side display, as illustrated in (b) of FIG. 23.

If the position of the rechargeable battery module in the mobile device is successfully aligned with the position of the wireless charger, charging is started, and a strip 2330 is displayed with its width changing periodically (wide->narrow->wide), as illustrated in (c) of FIG. 23.

The width of the strip 2330 is periodically changed until the battery is completely charged. However, if the mobile device is wrongly placed on the wireless charger, the strip 2320 guiding to an optimum position for wireless charging is displayed again, as illustrated in (b) of FIG. 23.

Finally, if the charging is completed, a whole area 2340 of the side display is illuminated in blue and is turned off a predetermined time later, as illustrated in (d) of FIG. 23. Therefore, the technical effect is achieved that the user recognizes completion of charging without viewing the front display.

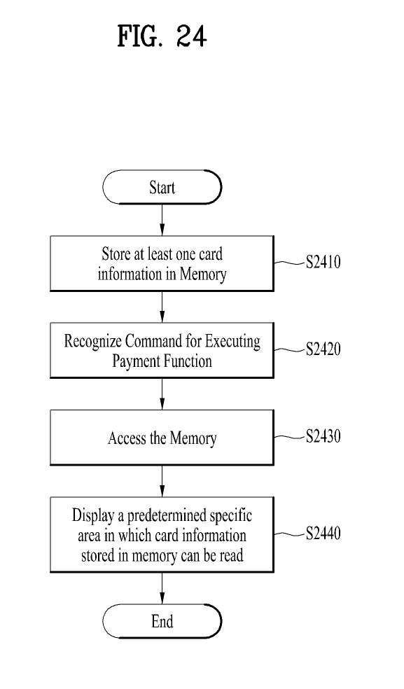

FIG. 24 is a flowchart illustrating a process of making a payment in a mobile device according to an embodiment of the present disclosure. Supplemental interpretation of FIG. 24 with reference to the previous drawings also falls within the scope of the present disclosure.

A method of controlling a mobile device according to an embodiment of the present disclosure is designed to include storing information about at least one card enabling payment in a memory (S2410), recognizing a command for executing a payment function (S2420), accessing the memory (S2430), and controlling display of a predetermined specific area in which the card information stored in the memory can be read, distinctly from other areas (S2440).

Therefore, a user does not need to memorize the position of an NFC or MST coil/antenna.

Meanwhile, the above-described present disclosure may be implemented as code that can be written as a processor-readable code on a processor-readable recording medium. The processor-readable recording medium may be any type of recording device in which data is stored in a computer-readable manner. Examples of the computer-readable recording medium include a read only memory (ROM), a random access memory (RAM), a compact disk ROM (CD-ROM), a magnetic tape, a floppy disc, an optical data storage, and a carrier wave such as data transmission over the Internet. Further, the processor-readable recording medium may be distributed to computer systems connected through a network, and thus a processor-readable code may be stored and executed in a distributed manner.

Meanwhile, while the present disclosure has been described with reference to the attached drawings, it is a mere embodiment, and the present disclosure is not limited to any particular embodiment. Various contents that can be modified by a person skilled in the art fall within the scope of the claims. Further, such modified embodiments should not be understood individually from the technical spirit of the present disclosure.

### MODE FOR INVENTION

Various embodiments have been described in the best mode for carrying out the invention.

### INDUSTRIAL APPLICABILITY

The present disclosure is applicable to a mobile device capable of making a mobile payment (e.g., a portable phone, a smartphone, a tablet PC, a smart watch, glasses, and so on), and it is acknowledged that the present disclosure is industrially applicable.

1. A mobile device comprising:
a camera;
a touch sensor;
a display module;
a short-range communication module;
a memory configured to store information about at least one card enabling payment for an item; and
a controller configured to control the touch sensor, the display module, and the memory,
wherein the controller is configured to control the display module to display a predetermined specific area in which the information about at least one card stored in the memory is to be read, distinctly from other areas, in response to a command for executing a payment function.

2. The mobile device according to claim 1, wherein the specific area overlaps with at least one of the position of a chip for near field communication (NFC) or the position of a chip for magnetic secure transmission (MST).

3. The mobile device according to claim 1, wherein the command for executing the payment function further includes a command for turning on an NFC function.

4. The mobile device according to claim 3, wherein if an NFC write mode is set, a virtual card is displayed in the specific area, and
wherein if an NFC read mode is set, a non-virtual card is displayed in the specific area.

5. The mobile device according to claim 1, wherein the camera is configured to capture an external point of sales (POS) terminal, and
wherein the controller is configured to recognize a type of the captured POS terminal with referring to the memory.

6. The mobile device according to claim 5, wherein the controller is configured to control the display module to display the captured POS terminal, and to additionally display a specific position of the POS terminal, in which the information about at least one card stored in the memory of the mobile device is to be read on the basis of the recognized type.

7. The mobile device according to claim 1, further comprising a side display module.

8. The mobile device according to claim 7, wherein if recognizing a change of a position of the mobile device by a motion sensor, the controller is configured to control the side display module to display the predetermined specific area in which the information about at least one card stored in the memory is to be read.

9. The mobile device according to claim 1, further comprising at least one vibration sensor.

10. The mobile device according to claim 9, wherein if recognizing a change in a position of the mobile device by a motion sensor, the controller is configured to control the at least one vibration sensor to vibrate the predetermined specific area in which the information about at least one card stored in the memory is to be read.

11. A method of controlling a mobile device, the method comprising:
storing information about at least one card enabling payment for an item in a memory;
recognizing a command for executing a payment function;
accessing the memory; and
controlling display of a predetermined specific area in which the information about at least one card stored in the memory is to be read, distinctly from other areas.

12. The method according to claim 11, wherein the specific area overlaps with at least one of the position of a chip for near field communication (NFC) or the position of a chip for magnetic secure transmission (MST).

13. The method according to claim 11, wherein the command for executing the payment function includes a command for turning on an NFC function.

14. The method according to claim 13, further comprising:
if an NFC write mode is set, displaying a virtual card in the specific area; and
if an NFC read mode is set, displaying a non-virtual card in the specific area.

15. The method according to claim 11, further comprising:
capturing an external point of sales (POS) terminal; and
recognizing a type of the captured POS terminal with referring to the memory.

16. The method according to claim 15, further comprising:
displaying the captured POS terminal; and
additionally displaying a specific position of the POS terminal, in which the information about at least one card stored in the memory of the mobile device is to be read on the basis of the recognized type.

17. The method according to claim 11, further comprising:
recognizing a change of a position of the mobile device by a motion sensor; and
controlling a side display module to display the predetermined specific area in which the information about at least one card stored in the memory is to be read.

18. The method according to claim 17, further comprising:
determining whether a payment has been completed within a predetermined time; and
changing the specific area displayed on the side display module according to a determination result.

19. The method according to claim 11, further comprising:
recognizing a change in a position of the mobile device by a motion sensor; and
controlling a vibration sensor to vibrate the predetermined specific area in which the information about at least one card stored in the memory is to be read.

20. The method according to claim 19, further comprising:
determining whether a payment has been completed within a predetermined time; and
changing a position or strength of a vibration generated by the vibration sensor according to a determination result.
